(19) United States
(12) Patent Application Publication
(10) Pub. No.: US 2004/0126468 A1
(43) Pub. Date: Jul. 1, 2004

(54) Food or edible material and beverages: processes, compositions, and products

(75) Inventors: William D. Holloway JR., Carlsbad, CA (US); Michael A. Holloway, Escondido, CA (US); Nikolai Tankovich, San Diego, CA (US); Eugene Baranov, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: AQUAPHOTONICS

(21) Appl. No.: 10/680,771

(22) Filed: Oct. 7, 2003

Related U.S. Application Data
(63) Continuation-in-part of application No. 09/698,537, filed on Oct. 26, 2000, now Pat. No. 6,521,248.
(60) Provisional application No. 60/161,546, filed on Oct. 26, 1999.

(51) Int. Cl. A23B 4/00

(52) U.S. Cl. 426/302

(57) ABSTRACT

Methods of hydrating foods and food ingredients in food processing systems with structured water. Edible foods, ingredients, flavoring and sweetening compositions containing structured water.

This application is a continuation-in-part of U.S. patent application Ser. No. 09/698,537, filed Oct. 26, 2000, and now U.S. Pat. No. 6,521,248.

### FIELD OF THE INVENTION

The present invention is directed to the use of structured water (also referred to herein as microcluster water) for hydrating ingredients and products of food processing systems, and to edible products or compositions which comprise structured water.

### BACKGROUND OF THE INVENTION

Water is composed of individual H20 molecules that may bond with each other through hydrogen bonding to form clusters that have been characterized as five species: un-bonded molecules, tetrahedral hydrogen bonded molecules comprised of five (5) H20 molecules in a quasi-tetrahedral arrangement and surface connected molecules connected to the clusters by 1,2 or 3 hydrogen bonds, (U.S. Pat. No. 5,711,950 Lorenzen; Lee H.). These clusters can then form larger arrays consisting of varying amounts of these micro-cluster molecules with weak long distance van der Waals attraction forces holding the arrays together by one or more of such forces as; (1) dipole-dipole interaction, i.e., electrostatic attraction between two molecules with permanent dipole moments; (2) dipole-induced dipole interactions in which the dipole of one molecule polarizes a neighboring molecule; and (3) dispersion forces arising because of small instantaneous dipoles in atoms. Under normal conditions the tetrahedral micro-clusters are unstable and reform into larger arrays from agitation, which impart London Forces to overcome the van der Waals repulsion forces. Dispersive forces arise from the relative position and motion of two water molecules when these molecules approach one another and results in a distortion of their individual envelopes of intra-atomic molecular orbital configurations. Each molecule resists this distortion resulting in an increased force opposing the continued distortion, until a point of proximity is reached where London Inductive Forces come into effect. If the velocities of these molecules are sufficiently high enough to allow them to approach one another at a distance equal to van der Waals radii, the water molecules combine.

There is currently a need for a process whereby large molecular arrays of liquids can be advantageously fractionated. Furthermore, there is a desire for smaller molecular (e.g., micro-clusters) of water for consumption, medicinal and chemical processes.

Foods and Beverages

Water is present in foods, which herein includes beverages, either as a constituent of food materials or added during food/beverage processing. The water in foods influences the physical and textural characteristics of the product as well as food's chemical stability. Control of water in foods is of primary importance for manipulating foods' structure, appearance, and stability, and can enable improvement in processing and storage of foods.

It is generally considered a necessity in the art of preparing food to use water as a mixing medium and source of hydration for ingredients.

Water exerts an influence before a product is made, during processing and in the finished product. Prior to processing, water acts as a solvent for many ingredients, allowing them to be activated and/or incorporated into the product mixture

Conventional art processes require amounts or aliquots of water to provide a mixing medium and to hydrate the components. With respect to hydration, water is supplied in sufficient quantity to ensure that specific ingredients are wetted and functionalized. With respect to use of water as a mixing medium, an amount of moisture is generally used so that ingredients can be contacted by suspension or dissolution in the medium. The overall process requires the use of moisture to provide solubility of the ingredients. In certain foods, unless the water is forcibly removed, the process will result in an incoherent product having no significant structural integrity.

Water is generally a major component of food, and frequently it is the major component. The chemical changes undergone by food systems during handling, processing, and storage are influenced by water composition. In food processing industries, understanding the relationships of water to foods has been central to the search for products of superior quality and longer shelf lives. Water composition is a major determinant of food safety, quality, texture, and other attributes of food products and ingredients.

Water's interactions with food components is studied in the context of aqueous solutions, dispersions, gels, and ice where the hydration behavior of ions, simple molecules and macromolecules is characterized.

Food attributes are known to be influenced by hydration of ions, molecules and macromolecules in the physico-chemical conditions of food processing systems. Hydration is a major factor in determining molecular conformation and flexibility of carbohydrates, proteins, and lipids. The experimental findings and the macroscopic manifestations of hydration phenomena are applicable to food technology. (P. Molyneux, Synthetic Polymers in “Water—A Comprehensive Treatise,” Vol. 4, F. Franks, ed., Plenum Press, NY (1975)). In aqueous systems, experimenters often focus on hydration, i.e. solute-water hydrogen bonding, as it relates to water-soluble or water-sensitive components of the food processing system. In food processing, water is considered a universal plasticizer of naturally occurring organic materials which form the basis of food products ( F. Franks, “Hydration Phenomena: an update and implications for the food processing industry; Advances in Experimental Medicine and Biology, 302: 1-19 (1991)). Water is both a reactant and a reaction medium, a stabilizer of biopolymer conformation, an influence on food structure, taste and appearance, and susceptibility to spoilage.

In a food system comprising a mixture of components, frequently the ability to take up water is different for each of the components of the mixture and it is not therefor unreasonable to believe that different amounts of water are associated with the different components. Consequently, a systematic understanding of the hydration of mixed systems is necessary. Experimentally, it has been shown that very often water is unequally distributed between the different components.

Physicochemical Properties of Food Materials

The physical state and physicochemical properties of food materials affect their behavior during processing, storage, distribution and consumption. Although fresh foods have diverse structural characteristics and compositions, their main components are carbohydrates, lipids, proteins, and water. Water interacts primarily with hydrophilic compounds, i.e. carbohydrates and proteins, and to a lesser extent with hydrophobic lipids.

The introduction of polymer science principles to food science has emphasized similarities between physicochemical properties of food biopolymers and synthetic polymers and the plasticizing properties of water. Foods are complex mixtures of solids and water, while polymers are composed of repeating units of well-characterized molecules.

Characterization of the physical state of food materials and application of the polymer science theories to the description of food properties and various kinetic phenomena have significantly contributed to the present understanding of food stability. Knowledge of material properties is extremely useful in the production of encapsulated flavors, extruded products, and confectionery, in the development of new products, such as dehydrates enzymes or starters, and in avoiding quality changes that may result from mechanical changes, such as loss of crispiness and recrystalization phenomena.

The structure of water allows explanation of many of its solvation properties of ions, hydrophobic molecules, carbohydrates and macromolecules. (Chaplin, M. F., (2000) A proposal for the structuring of water. Biophys. Chem., 83 (3), 211-221; Owen R. Fennema, Food Chemistry, 3rd Edition, Chapter 2.6 re structure of water.) Accordingly, the use of structured water for hydrating ingredients and products of food processing systems, and compositions of edible products or their ingredients which comprise structured water opens a new era in the art and science of foods and beverages.

### SUMMARY OF THE INVENTION

The inventors have discovered that liquids, which form large molecular arrays, such as through various electrostatic and van der Waal forces (e.g., water), can be disrupted through cavitation into fractionated or micro-cluster molecules (e.g., theoretical tetrahedral micro-clusters of water). The inventors have further discovered a method for stabilizing newly created micro-clusters of water by utilizing van der Waals repulsion forces. The method involves cooling the micro-cluster water to a desired density, wherein the micro-cluster water may then be oxygenated. The micro-cluster water is bottled while still cold. In addition, by overfilling the bottle and capping while the micro-cluster oxygenated water is dense (i.e., cold), the London forces are slowed down by reducing the agitation which might occur in a partially filled bottle while providing a partial pressure to the dissolved gases (e.g., oxygen) in solution thereby stabilizing the micro-clusters for about 6 to 9 months when stored at 40 to 70 degrees Fahrenheit.

The present invention provides a process for producing a micro-cluster liquid, such as water, comprising subjecting a liquid to cavitation such that dissolved entrained gases in the liquid form a plurality of cavitation bubbles; and subjecting the liquid containing the plurality of cavitation bubbles to a reduced pressure, wherein the reduction in pressure causes breakage of large liquid molecule matrices into smaller liquid molecule matrices. In another embodiment the liquid is substantially free of minerals and can be water which may also be substantially free of minerals. The embodiment provides for a process which is repeated until the water reaches about 140° C. (about 60° C.). The cavitation can be provided by subjecting the liquid to a first pressure followed by a rapid depressurization to a second pressure to form cavitation bubbles. The pressurization can be provided by a pump. In one embodiment the first pressure is about 55 psig to more than 120 psig. In another embodiment the second pressure is about atmospheric pressure. The embodiment can be carried out such that the pressure change caused the plurality of cavitation bubbles to implode or explode. The pressure change may be performed to create a plasma which dissociates the local atoms and reforms the atom at a different bond angle and strength. In another embodiment the liquid is cooled to about 4° C. to 15° C. Further embodiment comprises providing gas to the micro-cluster liquid, such as where the gas is oxygen. In a further embodiment the oxygen is provided for about 5 to about 15 minutes.

In a further embodiment the invention provides a process for producing a micro-cluster liquid, comprising subjecting a liquid to a pressure sufficient to pressurize the liquid; emitting the pressurized liquid such that a continuous stream of liquid is created; subjecting the continuous stream of liquid to a multiple rotational vortex having a partial vacuum pressure such that dissolved and entrained gases in the liquid form a plurality of cavitation bubbles; and subjecting the liquid containing the plurality of cavitation bubbles to a reduced pressure, wherein the plurality of cavitation bubbles implode or explode causing shockwaves that break large liquid molecule matrices into smaller liquid molecule matrices. In a further embodiment the liquid is substantially free of minerals and in an additional embodiment the liquid is water, preferably substantially free of minerals. The invention provides that the process can be repeated until the water reaches about 140° F. (about 60° C.). In another embodiment the cavitation is provided by subjecting the liquid to a first pressure followed by a rapid depressurization to a second pressure to form cavitation bubbles. Further the invention provides that the pressurization is provided by a pump. In a further embodiment the first pressure is about 55 psig to more than 120 psig and, in another embodiment the second pressure is about atmospheric pressure, including embodiments where the second pressure is less than 5 psig. The invention also provides for micro-cluster liquid where the pressure change causes the plurality of cavitation bubbles to implode or explode. In a further embodiment, the pressure change creates a plasma which dissociates the local atoms and reforms the atoms at a different bond angle and strength. The invention also provides a process where the liquid is cooled to about 4° C. to 15° C. In another embodiment, the invention provides subjecting a gas to the micro-cluster liquid. Preferably, the gas is oxygen, especially oxygen administered for about 5 to 15 minutes and more preferably at pressure from about 15 to 20 psig.

The present invention also provides for a composition comprising a micro-cluster water produced according to the procedures noted above.

Still another aspect of the invention is a micro-cluster water which has any or all of the properties of a conductivity of about 3.0 to 4.0 μmhos/cm, a FTIR spectrophotometric pattern with a major sharp feature at about 2650 wave numbers, a vapor pressure between about 40° C. and 70° C. as determined by thermogravimetric analysis, and an 170 NMR peak shift of at least about +30 Hertz, preferably at least about +40 Hertz relative to reverse osmosis water.

The present invention further provides for the use of the micro-cluster water of the invention for such purposes as modulating cellular performance and lowering free radical levels in cells by contacting the cell with the micro-cluster water.

The present invention further provides a delivery system comprising a micro-cluster water (e.g., an oxygenated microcluster water) and an agent, such as a nutritional agent, a medication, and the like.

Further, the micro-cluster water of the invention can be used to remove stains from fabrics by contacting the fabric with the micro-cluster water.

The invention provides a method of hydrating with structured water foods and their ingredients in food processing systems. The method involves the step of contacting for a sufficient period a sufficient aliquot of structured water with at least one of the ingredients or foods or products of a food processing system, thereby forming structured ingredients or products. The products of the method include edible products or compositions, an edible food product which comprises structured water in combination with nonfood material, flavoring composition, and a sweetening composition.

Products of the invention which comprise structured water include edible products or compositions, flavoring compositions, and sweetening compositions

Another aspect of the invention involves administering via the oral cavity a structured food product or composition to an animal or human, which has the step of feeding to the human or animal food products or compositions which comprise microclustered water.

The details of one or more embodiments of the invention are set forth in the accompanying drawings and the description below. Other features, objects, and advantages of the invention will be apparent from the description and drawings, and from the claims.

All publications, patents and patent applications cited herein are hereby expressly incorporated by reference for all purposes.

### BRIEF DESCRIPTION OF THE DRAWINGS

FIG. 1 shows a water molecule and the resulting net dipole moment.

FIG. 2 shows a large array of water molecules.

FIG. 3 shows a micro-cluster of water having 5 water molecules forming a tetrahedral shape.

FIG. 4 shows an example of a device useful in creating cavitation in a liquid. The device provides inlets for a liquid, wherein the liquid is then subjected to multiple rotational vortexes reaching partial vacuum pressures of about 27″ Hg. The liquid then exits the device at point A through an acceleration tube into a chamber less than the pressure within the device (e.g., about atmospheric pressure).

FIG. 5 shows FTIR spectra for RO water (FIG. 5(a)) and processed micro-cluster water (FIG. 5(b)).

FIG. 6 shows TGA plots for RO water and oxygenated micro-cluster water.

FIG. 7 shows NMR spectra for RO water (FIG. 7(a)), micro-cluster water without oxygenation (FIG. 7(b)) and micro-cluster water with oxygenation (FIG. 7(c)).

### DESCRIPTION OF THE PREFERRED EMBODIMENTS

Liquids, including for example, alcohols, water, fuels and combinations thereof, are comprised of atoms and molecules having complex molecular arrangements. Many of these arrangements result in the formation of large molecular arrays of covalently bonded atoms having non-covalent interactions with adjacent molecules, which in turn interact via additional non-covalent interactions with yet other molecules. These large arrays, although stable, are not ideal for many applications due to their size. Accordingly it is desirable to create and provide liquids having smaller arrays by reducing the number of non-covalent interactions. These smaller molecules are better able to penetrate and react in biological and chemical systems. In addition, the smaller molecular arrays provide novel characteristics that are desirable.

As used herein, “covalent bonds” means bonds that result when atoms share electrons. The term “non-covalent bonds” or “non-covalent interactions” means bonds or interactions wherein electrons are not shared between atoms. Such non-covalent interactions include, for example, ionic (or electrovalent) bonds, formed by the transfer of one or more electrons from one atom to another to create ions, interactions resulting from dipole moments, hydrogen bonding, and van der Waals forces. Van der Waals forces are weak forces that act between non-polar molecules or between parts of the same molecule, thus bringing two groups together due to a temporary unsymmetrical distribution of electrons in one group, which induces an opposite polarity in the other. When the groups are brought closer than their van der Waals radii, the force between them becomes repulsive because their electron clouds begin to interpenetrate each other.

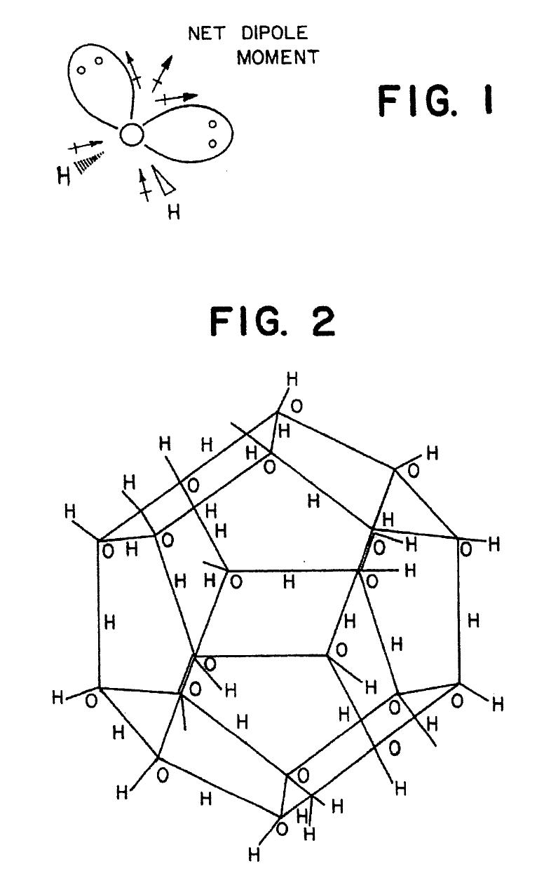

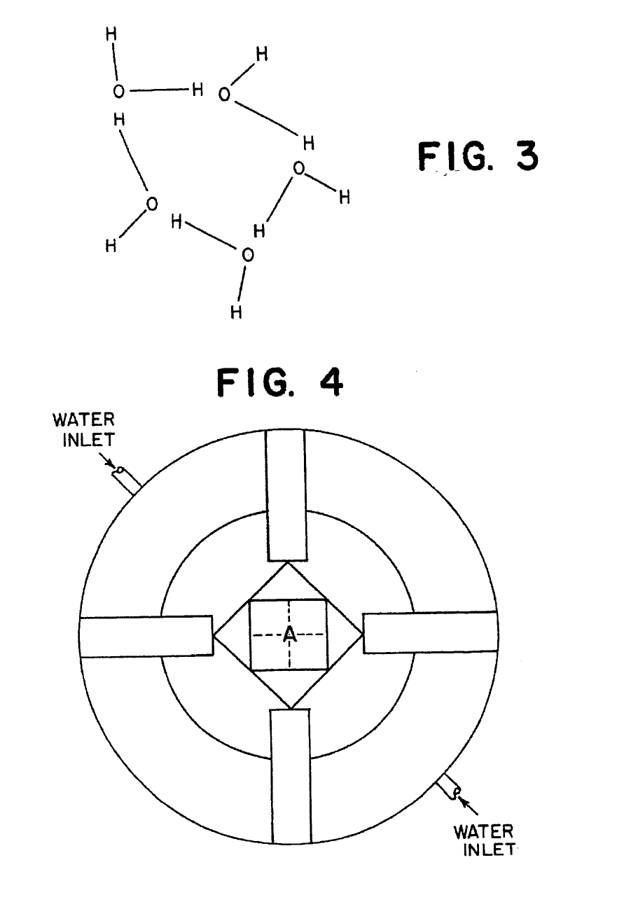

Numerous liquids are applicable to the techniques described herein. Such liquids include water; alcohols, petroleum and fuels. Liquids, such as water, are molecules comprising one or more basic elements or atoms (e.g., hydrogen and oxygen). The interaction of the atoms through covalent bonds and molecular charges form molecules. A molecule of water has an angular or bent geometry. The H-O-H bond angle in a molecule of water is about 104.5° to 105°. The net dipole moment of a molecule of water is depicted in FIG. 1. This dipole moment creates electrostatic forces that allow for the attraction of other molecules of water. Recent studies by Pugliano et al., (Science, 257:1937, 1992) have suggested the relationship and complex interactions of water molecules. These studies have revealed that hydrogen bonding and oxygen-oxygen interactions play a major role in creating large clusters of water molecules. Substantially purified water forms complex structures comprising multiple water molecules each interacting with an adjacent water molecule (as depicted in FIG. 2) to form large arrays. These large arrays are formed based upon, for example, non-covalent interactions such as hydrogen bond formation and as a result of the dipole moment of the molecule. Although highly stable, these large molecules have been suggested to be detrimental in various chemical and biological reactions. Accordingly, in one embodiment, the present invention provides a method of forming fractionized or micro-cluster water as depicted in FIG. 3 having as few as about 5 molecules of water.

The present invention provides small micro-cluster liquids (e.g., micro-cluster water molecules) a method for manufacturing fractionized or micro-cluster water and methods of use in the treatment of various biological conditions.

Accordingly, the present invention provides a method for manufacturing fractionized or micro-cluster liquids (e.g., water) comprising pressurizing a starting liquid to a first pressure followed by rapid depressurization to a second pressure to create a partial vacuum pressure that results in release of entrained gases and the formation of cavitation bubbles. The thermo-physical reactions provided by the implosion and explosion of the cavitation bubbles results in an increase in heat and the breaking of non-covalent interactions holding large liquid arrays together. This process can be repeated until a desired physical-chemical trait of the fractionized liquid is obtained. Where the liquid is water, the process is repeated until the water temperature reaches about 140° F. (about 60° C.). The resulting smaller or fractionized liquid is cooled under conditions that prevent reformation of the large arrays. As used herein, “water” or “a starting water” includes tap water, natural mineral water, and processed water such as purified water.

Any number of techniques known to those of skill in the art can be used to create cavitation in a liquid so long as the cavitating source is suitable to generate sufficient energy to break the large arrays. The acoustical energy produced by the cavitation provides energy to break the large liquid arrays into smaller liquid clusters. For example, the use of acoustical transducers may be utilized to provide the required cavitation source. In addition, cavitation can be induced by forcing the liquid through a tube having a constriction in its length to generate a high pressure before the constriction, which is rapidly depressurized following the constriction. Another example, includes forcing a liquid through a pump in reverse direction through a rotational volute.

In one embodiment, a liquid to be fractionized is pressurized into a rotational volute to create a vortex that reaches partial vacuum pressures releasing entrained gases as cavitation bubbles when the rotational vortex exits through a tapered nozzle at or close to atmospheric pressure. This sudden pressurization and decompression causes implosion and explosion of cavitation bubbles that create acoustical energy shockwaves. These shockwaves break the covalent and non-covalent bonds on the large liquid arrays, break the weak array bonds, and form micro-cluster or fractionized liquid consisting of, for example, about five (5) H20 molecules in a quasi tetrahedral arrangement (as depicted in FIG. 3), and impart an electron charge to the micro-cluster liquid thus producing electrolyte properties in the liquid. The micro-cluster liquid is recycled until desired number of micro-cluster liquid molecules are formed to reach a given surface tension and electron charge, as determined by the temperature rise of the liquid over time as cavitation bubbles impart kinetic heat to the processed liquid. Once the desired surface tension and electron charge are reached the micro-cluster liquid is cooled until liquid density increases. The desired surface tension and electron charge can be measured in any number of ways, but is preferably detected by temperature. Once the liquid reaches a desired density, typically at about 4 to 15° C., a gas, such as, for example, molecular oxygen, can be introduced for a sufficient amount of time to attain the desired quantity of oxygen in the micro-cluster liquid. The micro-cluster liquid is then aliquoted into a container or bottle, preferably filled to maximum capacity, and capped while the gassed micro-cluster liquid is still cool, so as to provide a partial pressure to the gassed micro-cluster liquid as the temperature reaches room temperature. This enables larger quantities of dissolved gas to be maintained in solution due to increased partial pressure on the bottles contents.

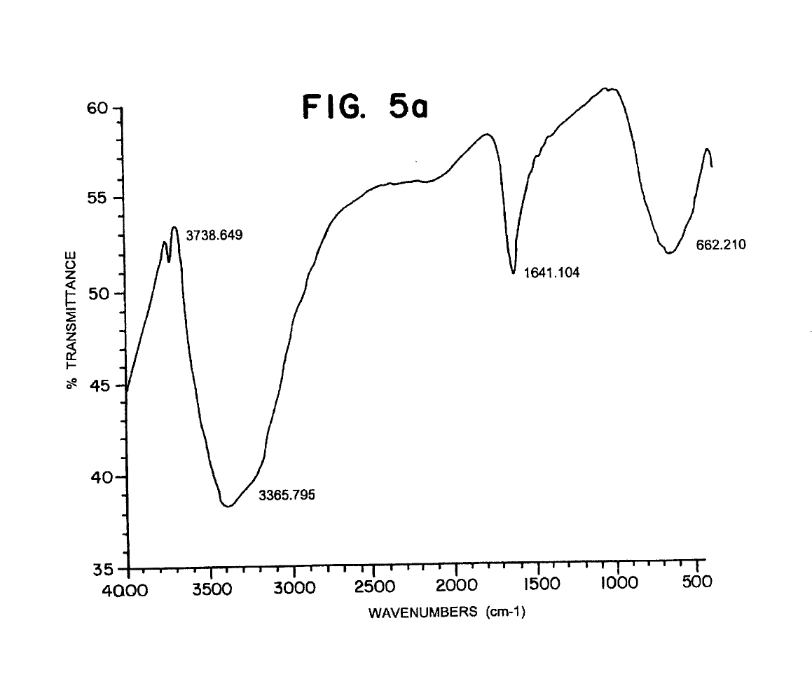

The present invention provides a method for making a micro-cluster or fractionized water or liquid, for ease of explanation water will be used as the liquid being described, however any type liquid may be substituted for water. A starting water such as, for a example, purified or distilled water is preferably used as a base material since it is relatively free of mineral content. The water is then placed into a food grade stainless steel tank for processing. By subjecting the starting water to a pump capable of supplying a continuous pressure of between about 55 and 120 psig or higher a continuous stream of water is created. This stream of water is then applied to a suitable device (see for example FIG. 4) capable of establishing a multiple rotational vortex reaching partial vacuum pressures of about 27″ Hg, thereby reaching the vapor pressure of dissolved entrained gases in the water. These gases form cavitation bubbles that travel down multiple acceleration tubes exiting into a common chamber at or close to atmospheric pressure. The resultant shock waves produced by the imploding and exploding cavitation bubbles breaks the large water arrays into smaller water molecules by repeated re-circulation of the water. The recycling of the water creates increases results in an increase in temperature of the water. The heat produced by the imploding and exploding cavitation bubbles release energy as seen in sonoluminescence, in which the temperature of sonoluminance bubbles are estimated to range from 10 to 100 eV or 2,042.033 degrees Fahrenheit at 19,743,336 atmospheres. However the heat created is at a sub micron size and is rapidly absorbed by the surrounding water imparting its kinetic energy. The inventors have determined that the breaking of these large arrays into smaller water molecules can be manipulated through a sinusoidal wave utilizing cavitation, and by monitoring the rise in temperature one can adjust the osmotic pressure and surface tension of the water under treatment. The inventors have determined that the ideal temperature for oxygenated micro-cluster water (Penta-hydrate™) is about 140 degrees F. (about 60° C.). This can be accomplished by using four opposing vortex volutes with a 6-degree acceleration tube exiting into a common chamber at or close to atmospheric pressure, less than 5 pounds backpressure.

As mentioned above, the inventors have also discovered that liquids undergo a sinusoidal fluctuation in heat/temperature under the process described herein. Depending upon the desired physical-chemical traits, the process is repeated until a desired point in the sinusoidal curve is established at which point the liquid is collected and cooled under, conditions to inhibit the formation of large molecular arrays. For example, and not by way of limitation, the inventors have discovered that water processed according to the methods described herein undergoes a sinusoidal heating process. During the production of this water a high negative charge is created and imparted to the water. Voltages of −350 mV to−1 volt have been measured with a superimposed sinusoidal wave with a frequency of 800 cycles or higher depending on operating pressures and subsequent water velocities. The inventors have found that the third sinusoidal peak in temperature provides an optimal number of micro-cluster structures for water. Although the inventors are under no duty to provide the mechanism or theory of action, it is believed that the high negative ion production serves as a ready source of donor electrons to act as antioxidants when consumed and further act to stabilize the water micro-clusters and help prevent reformation of the large arrays by aligning the water molecules exposed to the electrostatic field of the negative charge. While not wanting to be bound to a particular theory, it is believed that the high temperatures achieved during cavitation may form a plasma in the water which dissociates the H20 atoms and which then reform at a different bond association, as evidenced by the FTIR and NMR test data, to generate a different structure.

It will be recognized by those skilled in the art that the water of the present invention can be further modified in any number of ways. For example, following formation of the micro-cluster water, the water may be oxygenated as described herein, further purified, flavored, distilled, irradiated, or any number of further modifications known in the art and which will become apparent depending on the final use of the water.

In another embodiment, the present invention provides methods of modulating the cellular performance of a tissue or subject. The micro-cluster water (e.g., oxygenated microcluster water) can be designed as a delivery system to deliver hydration, oxygenation, nutrition, medications and increasing overall cellular performance and exchanging liquids in the cell and removing edema. Tests accomplished utilizing an RJL Systems Bio-Electrical Impedance Analyzer model BIA101 Q Body Composition Analysis System™ demonstrated substantial intracellular and extracellular hydration, changes in as little as 5 minutes. Tests were accomplished on a 58-year-old male 71.5″ in height 269 lbs, obese body type. Baseline readings were taken with Bio-Electrical Impedance Analyzer™ as listed below.

As described in the Examples below it is contemplated that the micro-cluster water of the present invention provides beneficial effects upon consumption by a subject. The subject can be any mammal (e.g, equine, bovine, porcine, murine, feline, canine) and is preferably human. The dosage of the micro-cluster water or oxygenated micro-cluster water (Penta-hydrate™) will depend upon many factors recognized in the art, which are commonly modified and adjusted. Such factors include, age, weight, activity, dehydration, body fat, etc. Typically 0.5 liters of the oxygenated micro-cluster water of the invention provide beneficial results. In addition, it is contemplated that the micro-cluster water of the invention may be administered in any number of ways known in the art, including, for example, orally and intravenously alone or mixed with other agents, compounds and chemicals. It is also contemplated that the water of the invention may be useful to irrigate wounds or at the site of a surgical incision. The water of the invention can have use in the treatment of infections, for example, infections by anaerobic organisms may be beneficially treated with the micro-cluster water (e.g., oxygenated microcluster water).

In another embodiment, the micro-cluster water of the invention can be used to lower free radical levels and, thereby, inhibit free radical damage in cells. In still another embodiment the micro-cluster water of the invention can be used to remove stains from fabrics, such as cotton.

The following examples are meant to illustrate but no limit the present invention. Equivalents of the following examples will be recognized by those skilled in the art and are encompassed by the present disclosure.

### EXAMPLE 1

How to Make Micro-Cluster Water

Described below is one example of a method for making micro-cluster liquids. Those skilled in the art will recognize alternative equivalents that are encompassed by the present invention. Accordingly, the following examples is not to be construed to limit the present invention but are provided as an exemplary method for better understanding of the invention.

325 gallons of steam distilled water from Culligan Water or purified in 5 gallon bottles at a temperature about 29 degrees C. ambient temperature, was placed in a 316 stainless steel non-pressurized tank with a removable top for treatment. The tank was connected by bottom feed 2¼″ 316 stainless steel pipe that is reduced to 1″ NPT into a 20″ U.S. filter housing containing a 5 micron fiber filter, the filter serves to remove any contaminants that may be in the water. Output of the 20″ filter is connected to a Teel model 1 V458 316 stainless steel Gear pump driven by a 3HP 1740 RPM 3 phase electric motor by direct drive. Output of the gear pump 1″ NPT was directed to a cavitation device via 1″ 316 stainless steel pipe fitted with a 1″ stainless steel ball valve used for isolation only and pasta pressure gauge. Output of the pump delivers a continuous pressure of 65 psig to the cavitation device.

The cavitation device was composed of four small inverted pump volutes made of Teflon without impellers, housed in a 316 stainless steel pipe housing that are tangentially fed by a common water source fed by the 1 V458 Gear pump at 65 psig, through a ¼″ hole that would normally be used as the discharge of a pump, but are utilized as the input for the purpose of establishing a rotational vortex. The water entering the four volutes is directed in a circle 360 degrees and discharged through what would normally be the suction side of a pump by the means of an 1″ long acceleration tube with a ⅜″ discharge hole, comprising what would normally be the suction side of a pump volute but in this case is utilized as the discharge side of the device. The four reverse fed volutes establish rotational vortexes that spin the water one 360 degree rotation and then discharge the water down the 5 degree decreasing angle from center line, acceleration tubes discharging the water into a common chamber at or close to atmospheric pressure. The common chamber was connected to a 1″ stainless steel discharge line that fed back into the top of the 325-gallon tank containing the distilled water. At this point the water made one treatment trip through the device.

The process listed above is repeated continuously until the energy created by the implosions and explosions of the cavitation (e.g., due to the acoustical energy) have imparted its kinetic heat into the water and the water is at about 60 degrees Celsius. Although the inventors are under no duty to explain the theory of the invention, the inventors provide the following theory in the way of explanation and are not to be bound by this theory. The inventors believe that the acoustical energy created by the cavitation brakes the static electric bonds holding a single tetrahedral Micro-Clusters of five H20 molecules together in larger arrays, thus decreasing their size and/or create a localized plasma in the water restructuring the normal bond angles into a different structure of water.

The temperature was detected by a hand held infrared thermal detector through a stainless stell thermo well. Other methods of assessing the temperature will be recognized by those of skill in the art. Once the temperature of 60 degrees C. has been reached the pump motor is secured and the water is left to cool. An 8 foot by 8 foot insulated room fitted with a 5,000 Btu. air conditioner is used to expedite cooling, but this is not required. It is important that the processed water not be agitated for cooling it should be moved as little as possible.

A cooling temperature of 4 degrees C. can be used, however 15 degrees C. is sufficient and will vary depending upon the quantity of water being cooled. Once sufficiently cooled to about 4 to 15 degrees C. the water can be oxygenated.

Once the water is cooled to desired temperature, the processed water is removed from the 325 gallon stainless steel tank into 5-gallon polycarbonate bottles for oxygenation. Oxygenation is accomplished by applying gas O2 at a pressure of 20 psig fed through a ¼″ ID plastic line fitted with a plastic air diffuser utilized to make fine air bubbles (e.g., Lee's Catalog number 12522). The plastic tube is run through a screw on lid of the 5 gallon bottle until it reaches the bottom of the bottle. The line is fitted with the air diffuser at its discharge end. The Oxygen is applied at 20 psig flowing pressure to insure a good visual flow of oxygen bubbles. In one embodiment (Penta-hydrate™M) the water is oxygenated for about five minutes and in another embodiment (Penta-hydrate Pro™) the water is oxygenated for about ten minutes.

Immediately after oxygenation the water is bottled in 500 ml PET bottles, filled to overflowing and capped with a pressure seal type plastic cap with inserted seal gasket. In one embodiment, the 0.5 L bottle is over filled so when the temperature of the water increases to room temperature it will self pressurize the bottle retaining a greater concentration of dissolved oxygen at partial pressure. This step not only keeps more oxygen in a dissolved state but also for preventing excessive agitation of the water during shipping.

### EXAMPLE 2

The following are reports from individuals who used the water of the invention.

Elimination Of Edema:

Patient A: A 66-year-old Male presenting with (ALS) Amyothrophic Lateral Sclerosis (Lou Gherig's Disease) exhibited a shoulder hand syndrome with marked swelling of the left hand. This hand being the predominately affected limb. After consuming 500 ml of Penta-hydrate™ micro-cluster water the swelling of the left hand was dramatically reduced to normal state. Additional tests were accomplished over several weeks noting the same reduction of edema after consuming Penta-hydrate™ micro-cluster water. When Penta-hydrate™ was discontinued edema reoccurred overnight, upon consuming 500 ml of Penta-hydrate™ micro-cluster water edema was reduced within 4 to 6 hours.

Patient B: Is a 53 year old female with multijoint Acute Rheumatoid Arthritis of 6 year duration. She has been taking diuretics for dependent edema on a daily basis for 4 years. She began taking Penta-hydrate™ Micro-Cluster Water, 5 months ago in place of diuretics, consuming three (3) 500 ml bottles daily. Within one day the edema of the feet/legs and hands cleared. When Penta-hydrate™ was discontinued during a trip, the edema promptly returned. Upon resumption of Penta-hydrate™ Micro-Cluster Water the edema quickly cleared.

Increased Physical Endurance:

A 56-year-old woman diagnosed with “severe emphysema” and retired on full disability underwent experimental lung reduction surgery in December 1998 at St Elizabeth's Hospital in Boston. Each of the lungs upper lobes were removed and re-sectioned. While the surgery was deemed successful the patient had begun to deteriorate. The depression and loss of stamina was overcome by Oxy-Hi-drate Pro™: A 2⅓ increase in endurance is usually seen in response to subject taking Penta-hydrate™ and is caused by increased delivery of hydration to the cells, which is the delivery system for increased oxygenation and cellular energy production. Tests on numerous test subjects show marked increase in cellular hydration within 10 minutes of consuming Penta-hydrate™ micro-cluster water.

Decreased Lactic Acid Soreness from Exercise:

The inventors have received reports of reduced or eliminated soreness caused by lactic acid buildup during exercise as well as increased endurance and performance after consuming Penta-hydrate™ micro-cluster water. This includes elderly fibromyalgia patients. Penta-hydrate™ micro-cluster is thought to delay or prevent the on set of anaerobic cellular function by increasing cellular water and oxygen exchange keeping the cells operating aerobic condition for a longer time period during strenuous exercise, thus preventing or delaying the buildup of lactic acid in the body.

Increased Athletic Performance:

Test accomplished on three high performance athletes have demonstrated a marked increase in overall performance.

A 29 year old male Tri-athlete competing in the 1999 Coronado California 21St annual Super Frog Half Iron Man Triathlon consumed (6) six 500 ml bottles of Penta-hydrate™ Micro-Cluster the day prior to the race and (6) six 500 ml bottles of Penta-hydrate™ during the race posted a finish time of 4:19:37 winning the overall male winner, finishing over 24 minutes ahead of the second place finisher in his age group and beating the combined time of the Navy SEAL Relay Team One's time of 4:26:09 which had a fresh man for each leg of the three events. Normally after such a demanding race this athlete would be extremely sore the next day, however drinking the Penta-hydrate™ Micro-Cluster Water he was not sore and competed in a 20 K cycle qualifier the following day. Subject Tri-Athlete has won numerous Triathlons' and qualified for the 1999 World-Championships in Australia.

A 39 year old male Tri-athlete competing in the San Diego Second Annual Duadrome World Championships on August 8th 1999 at the Morley Field Velodrome. Subject athlete was pre hydrated with Penta-hydrate™ Micro-Cluster Water set a new world record winning the 35-39 age group division, beating his own best time by 26 seconds in the male relay division and the course record by 3 seconds

Both of the above Tri-athletes report dramatic increase in endurance and rapid recovery after strenuous exercise not experienced with conventional water and an ability to hydrate during the running portion of a triathlon, normally hydration is only accomplished during the cycling portion of a triathlon, due to normal water causing the subject to regurgitate, this problem is not encountered drinking Penta-hydrate™ Micro-Cluster Water due to its rapid absorption.

45-year-old woman TV 10 News anchor in San Diego, that also competes in rough ocean swimming. Consumed 500 ml of Penta-hydrate™ just prior to entering the water in a swim meet in Hawaii; won the gold medal in 45-year-old age division. Returned to San Diego and competed in the La Jolla rough water swim and won a gold medal. Next competed in the US Nationals held at Catalina Island in California and won the US National Gold Medal after drinking 500 ml of Penta-hydrate™ just prior to entering the water. She was not considered a contender for the Gold in the US Nationals.

Congestive Heart Failure:

The inventors have had several reports from subjects with congestive heart failure report ten minutes after consuming 500 ml of Penta-hydrate Pro™ their shortness of breath had gone away and their energy was increased.

Muscular Sclerosis MS:

A woman with Muscular Sclerosis was rushed to the hospital in San Antonio Texas having passed out from severe dehydration. The MS subject drank×500 ml bottles of Penta-hydrate™ their and was re-hydrated.

Colds, Flu, Sinus Infections and Energy:

58-year-old male with loss of spleen and 20-year sufferer of fibromyalgia, suffered from chronic sinus infections and annual bouts of the flu and reoccurring bouts of pneumonia. He started drinking 6-500 ml bottles of Penta-hydrate™ Micro-Cluster Water per day 19 months ago. At that time he had a severe sinus infection that would have normally required antibiotics. While taking the Penta-hydrate™ Micro-Cluster Water, the sinus infection was cleared within three days and subject has not had a single sinus infection in 19 months. In addition he has not experienced any colds, flu or allergy conditions and is now for the first time in 20-years able to work with out fatigue.

Elimination of Edema:

In numerous test cases Penta-hydrate™ has eliminated edema in all test subjects from both chronic health conditions as well as surgically caused edema. In all cases edema was dramatically reduced after consuming as little as one 500 ml bottle of Penta-hydrate™ Micro-Cluster Water but no more than two 500 ml bottles were required. One such case was a middle-aged woman that had broken her forearm in two places. The forearm was in a cast and suffering severs edema, subject was given two 500 ml bottles of Penta-hydrate™ Micro-Cluster Water that she consumed from 3:00 pm until bedtime. Swelling was so bad that she could not insert a business card between her swollen arm and the cast. When she awoke at 7:00 am the next morning the swelling was reduced to where she was endanger of loosing the cast and had to return to the orthopedic surgeon to have the cast redone.

Liquid Nutritional Analyzer Results.

Liquid nutritional analyzer results utilizing a RJL Systems BIA101QTM FDA registered analyzer for assessing cellular hydration and health. The following measurements were preformed on a 58 year-old male subject.

Time: 7:59 am Oct. 9, 1999 Baseline Test:

| | |
|---|---|
| Measured: Resistance: 413 ohms | Reactance: 53 ohms |
| Calculated: Impedance 416 ohms | Phase Angle: 7.3 degrees |
| Parallel Model: Resistance: 419.8 ohms | Capacitance: 973.0 pF |

| | | | | |
|---|---|---|---|---|
| Fluid Assessment: | | | | |
| Status: (Edema) | Results: | Percent: | Normal Range: | Deviation: |
| Total Body Water | 63.3 L | 52% (WT) | 40%-50% | +2 |
| Intracellular Water | 37.5 L | 59% (TBW) | 51%-60% | +0 |
| Extracellular Water | 25.8 L | 41% (TBW) | 39%-51% | +0 |

| | | |
|---|---|---|
| Nutrition Assessment: | | |
| Basal Metabolism | 2069 Kcal | |
| Body Cell Mass | 90.6 lbs. | 34% (WT) |
| Fat Free Mass | 190.2 lbs. | 71% |
| Fat | 78.8 lbs. | 29% |
| ECT | 99.6 lbs. | 52% |
| Impedance Index | 1437 Normal | |

Time: 8:02 am consumed 500 ml Penta-hydrate Pro ™

Time: 8:12 am Oct. 9, 1999

| | |
|---|---|
| Measured: Resistance: 436 ohms | Reactance: 57 ohms |
| Calculated: Impedance 439.7 ohms | Phase Angle: 7.4 degrees |
| Parallel Model: Resistance: 443.5 ohms | Capacitance: 938.4 pF |

| | | | | |
|---|---|---|---|---|
| Fluid Assessment: | | | | |
| Status: (Edema) | Results: | Percent: | Normal Range: | Deviation: |
| Total Body Water | 63.3 L | 51% (WT) | 40%-50% | +1 |
| Intracellular Water | 37.1 L | 60% (TBW) | 51%-60% | +0 |
| Extracellular Water | 25.2 L | 40% (TBW) | 39%-51% | +0 |

| | | |
|---|---|---|
| Nutrition Assessment: | | |
| Basal Metabolism | 2060 Kcal | |
| Body Cell Mass | 89.6 lbs. | 33% (WT) |
| Fat Free Mass | 188.0 lbs. | 70% |
| Fat | 81.0 lbs | 30% |
| ECT | 99.6 lbs. | 52% |
| Impedance Index | 1469 Normal | |

Time: 8:38 am Oct. 9, 1999

| | |
|---|---|
| Measured: Resistance: 442 ohms | Reactance: 56 ohms |
| Calculated: Impedance 445.5 ohms | Phase Angle: 7.2 degrees |
| Parallel Model: Resistance: 449.1 ohms | Capacitance: 898.0 pF |

| | | | | |
|---|---|---|---|---|
| Fluid Assessment: | | | | |
| Status: (Edema) | Results: | Percent: | Normal Range: | Deviation: |
| Total Body Water | 62.0 L | 51% (WT) | 40%-50% | +1 |
| Intracellular Water | 36.6 L | 60% (TBW) | 51%-60% | +0 |
| Extracellular Water | 25.4 L | 40% (TBW) | 39%-51% | +0 |

| | | |
|---|---|---|
| Nutrition Assessment: | | |
| Basal Metabolism | 2048 Kcal | |
| Body Cell Mass | 88.4 lbs. | 33% (WT) |
| Fat Free Mass | 187.5 lbs. | 70% |
| Fat | 81.5 lbs. | 30% |
| ECT | 99.1 lbs. | 53% |
| Impedance Index | 1426 Normal | |

Time: 8:43 am Oct. 9, 1999

| | |
|---|---|
| Measured: Resistance: 453 ohms | Reactance: 57 ohms |
| Calculated: Impedance 456.6 ohms | Phase Angle: 7.2 degrees |
| Parallel Model: Resistance: 460.2 ohms | Capacitance: 874.0 pF |

| | | | | |
|---|---|---|---|---|
| Fluid Assessment: | | | | |
| Status: (Edema) | Results: | Percent: | Normal Range: | Deviation: |
| Total Body Water | 63.6 L | 50% (WT) | 40%-50% | +0 |
| Intracellular Water | 36.2 L | 59% (TBW) | 51%-60% | +0 |
| Extracellular Water | 25.3 L | 41% (TBW) | 39%-51% | +0 |

| | | |
|---|---|---|
| Nutrition Assessment: | | |
| Basal Metabolism | 2040 Kcal | |
| Body Cell Mass | 87.6 lbs. | 33% (WT) |
| Fat Free Mass | 186.5 lbs. | 69% |
| Fat | 82.5 lbs. | 31% |
| ECT | 99.0 lbs. | 53% |
| Impedance Index | 1421 Normal | |

Time: 8:45 Consumed additional 500 ml Penta-hydrate ProTM

Time: 8:48 a.m. Oct. 9, 1999

| | |
|---|---|
| Measured: Resistance: 431 ohms | Reactance: 60 ohms |
| Calculated: Impedance 435.2 ohms | Phase Angle: 7.9 degrees |
| Parallel Model: Resistance: 439.4 ohms | Capacitance: 1008.6 pF |

| | | | | |
|---|---|---|---|---|
| Fluid Assessment: | | | | |
| Status: (Edema) | Results: | Percent: | Normal Range: | Deviation: |
| Total Body Water | 62.5 L | 51% (WT) | 40%-50% | +1 |
| Intracellular Water | 37.9 L | 61% (TBW) | 51%-60% | +1 |
| Extracellular Water | 24.5 L | 39% (TBW) | 39%-51% | +0 |

| | | |
|---|---|---|
| Nutrition Assessment: | | |
| Basal Metabolism | 2078 Kcal | |
| Body Cell Mass | 91.7 lbs. | 34% (WT) |
| Fat Free Mass | 188.4 lbs. | 70% |
| Fat | 80.6 lbs. | 30% |
| ECT | 96.8 lbs. | 52% |
| Impedance Index | 1561 Normal | |

Time: 9:39 consumed 500 ml Penta-hydrate ™

Time: 9:07 am Oct. 9, 1999

| | |
|---|---|
| Measured: Resistance: 442 ohms | Reactance: 57 ohms |
| Calculated: Impedance: 445.7 ohms | Phase Angle: 7.3 degrees |
| Parallel Model: Resistance: 449.4 ohms | Capacitance: 913.5 pF |

| | | | | |
|---|---|---|---|---|
| Fluid Assessment: | | | | |
| Status: (Edema) | Results: | Percent: | Normal Range: | Deviation: |
| Total Body Water | 62.0 L | 51% (WT) | 40%-50% | +1 |
| Intracellular Water | 36.8 L | 59% (TBW) | 51%-60% | +0 |
| Extracellular Water | 25.2 L | 41% (TBW) | 39%-51% | +0 |

| | | |
|---|---|---|
| Nutrition Assessment: | | |
| Basal Metabolism | 2053 Kcal | |
| Body Cell Mass | 88.9 lbs. | 33% (WT) |
| Fat Free Mass | 187.5 lbs. | 70% |
| Fat | 81.5 lbs. | 30% |
| ECT | 98.6 lbs. | 53% |
| Impedance Index | 1452 Normal | |

Time: 9:27 am Oct. 9, 1999

| | |
|---|---|
| Measured: Resistance: 427 ohms | Reactance: 56 ohms |
| Calculated: Impedance 430.7 ohms | Phase Angle: 7.5 degrees |
| Parallel Model: Resistance: 434.3 ohms | Capacitance: 961.1 pF |

| | | | | |
|---|---|---|---|---|
| Fluid Assessment: | | | | |
| Status: (Edema) | Results: | Percent: | Normal Range: | Deviation: |
| Total Body Water | 62.7 L | 51% (WT) | 40%-50% | +1 |
| Intracellular Water | 37.4 L | 60% (TBW) | 51%-60% | +0 |
| Extracellular Water | 25.3 L | 40% (TBW) | 39%-51% | +0 |

| | | |
|---|---|---|
| Nutrition Assessment: | | |
| Basal Metabolism | 2066 Kcal | |
| Body Cell Mass | 90.3 lbs. | 34% (WT) |
| Fat Free Mass | 188.8 lbs. | 70% |
| Fat | 80.2 lbs. | 30% |
| ECT | 98.5 lbs. | 52% |
| Impedance Index | 1471 Normal | |

Time: 9:46 am Oct. 9, 1999

| | |
|---|---|
| Measured: Resistance: 430 ohms | Reactance: 59 ohms |
| Calculated: Impedance 434.0 ohms | Phase Angle: 7.8 degrees |
| Parallel Model: Resistance: 438.1 ohms | Capacitance: 996.9 pF |

| | | | | |
|---|---|---|---|---|
| Fluid Assessment: | | | | |
| Status: (Edema) | Results: | Percent: | Normal Range: | Deviation: |
| Total Body Water | 62.0 L | 51% (WT) | 40%-50% | +1 |
| Intracellular Water | 37.8 L | 60% (TBW) | 51%-60% | +0 |
| Extracellular Water | 24.7 L | 40% (TBW) | 39%-51% | +0 |

| | | |
|---|---|---|
| Nutrition Assessment: | | |
| Basal Metabolism | 2075 Kcal | |
| Body Cell Mass | 91.3 lbs. | 34% (WT) |
| Fat Free Mass | 188.5 lbs. | 70% |
| Fat | 80.5 bs. | 30% |
| ECT | 97.2 lbs. | 52% |
| Impedance Index | 1539 Normal | |

Time: 10:32 am Oct. 9, 1999

| | |
|---|---|
| Measured: Resistance: 437 ohms | Reactance: 57 ohms |
| Calculated: Impedance 440.7 ohms | Phase Angle: 7.4 degrees |
| Parallel Model: Resistance: 444.4 ohms | Capacitance: 934.2 pF |

| | | | | |
|---|---|---|---|---|
| Fluid Assessment: | | | | |
| Status: (Edema) | Results: | Percent: | Normal Range: | Deviation: |
| Total Body Water | 62.2 L | 51% (WT) | 40%-50% | +1 |
| Intracellular Water | 37.0 L | 60% (TBW) | 51%-60% | +0 |
| Extracellular Water | 25.2 L | 40% (TBW) | 39%-51% | +0 |

| | | |
|---|---|---|
| Nutrition Assessment: | | |
| Basal Metabolism | 2058 Kcal | |
| Body Cell Mass | 89.5 lbs. | 33% (WT) |
| Fat Free Mass | 187.9 lbs. | 70% |
| Fat | 81.1 lbs. | 30% |
| ECT | 98.4 lbs. | 52% |
| Impedance Index | 1466 Normal | |

Although test subjects were well hydrated prior to testing, the results were dramatic. Analysis of the above tests clearly show rapid cellular fluid exchange not possible with current hydrating fluid hydrating technology, including intravenous hydration methods. Similar tests utilizing tap and purified water demonstrated no change in cellular fluid exchanges over the same time frames. Note even though over-hydration increased total body water, the intercellular and extracellular remained within normal range with rapid noted in and out exchanges seen in both intercellular and extracellular fluids. And a 1.0% decrease in edema is noted after consuming only 500 ml of Penta-hydrate™ micro-cluster water. It is worth noting that the base micro-cluster water without oxygen is even more dramatic, hydrating the cells in less time than the oxygenated version micro-cluster water. The overall change in the Impedance Index of 124 points is utilized by the RJA System as an overall indication of health. Changes of this magnitude are not seen in a 90 day period of monitoring in the absence of oxygenated micro-cluster water (Penta-hydrate™ Micro-Cluster Water). However, when Penta-hydrate™ Micro-Cluster Water was consumed the 124 point change occurred within a 2.5 hour period.

### EXAMPLE 3

A novel water prepared by the method of the invention was characterized with respect to various parameters.

A. Conductivity

Conductivity was tested using the USP 645 procedure that specifies conductivity measurements as criteria for characterizing water. In addition to defining the test protocol, USP 645 sets performance standards for the conductivity measurement system, as well as validation and calibration requirements for the meter and conductivity.

Conductivity testing was performed by West Coast Analytical Service, Inc. in Santa Fe Springs, Calif.

Conductivity Test Results

| | | Micro-cluster | Micro-cluster |
|---|---|---|---|
| w/0₂ | RO Water | Water | Water |
| Conductivity at 25° C.* | 5.55 | 3.16 | 3.88 |
| (μmhos/cm) | | | |

*Conductivity values are the average of two measurements.

The conductivity observed for the micro-cluster water is reduced by slightly more than half compared to the RO water. This is highly significant and indicates that the micro-cluster water exhibits significantly different behavior and is therefore substantively different, relative to RO unprocessed water.

B. Fourier Transform Infra Red Spectroscopy (FTIR)

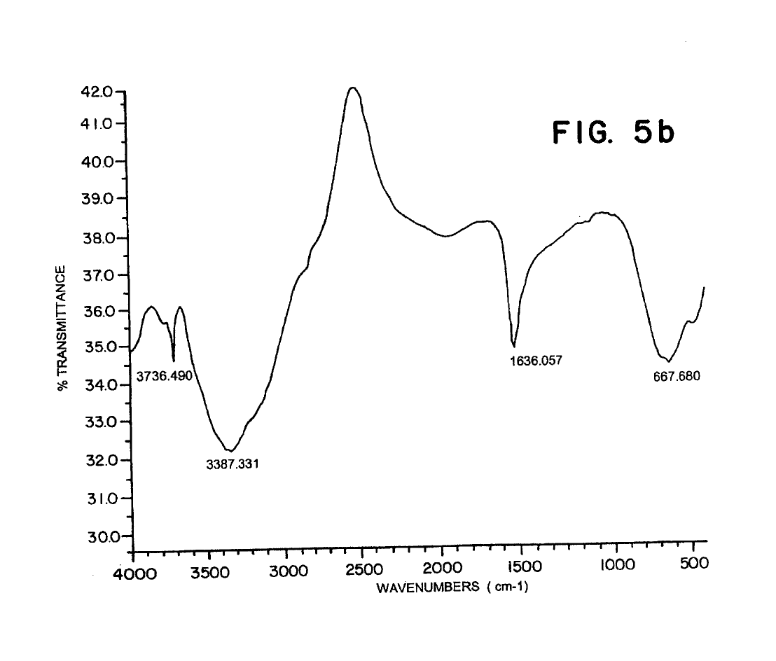

Water, a strong absorber in the IR spectral region, has been well-characterized by FTIR and shows a major spectral line at approximately 3000 wave numbers corresponding to O-H bond vibrations. This spectral line is characteristic of the hydrogen bonding structure in the sample. An unprocessed RO water sample, Sample A, and a unoxygenated micro-cluster water sample, Sample B, were each placed between silver chloride plates, and the film of each liquid analyzed by FTIR at 25° C. The FTIR tests were performed by West Coast Analytical Service, Inc. in Santa Fe Springs, Calif. using a Nicolet Impact 400DTM benchtop FTIR. The FTIR spectra are shown in FIG. 5.

In comparing the FTIR spectra for the unoxygenated micro-cluster and RO waters, it is clear that the two samples have a number of features in common, but also significant differences. A major sharp feature at approximately 2650 wave numbers in the FTIR spectrum is observed for the micro-cluster water (FIG. 5(b)). The RO water has no such feature (FIG. 5(a)). This indicates that the bonds in the water sample are behaving differently and that their energetic interaction has changed. These results suggest that the unoxygenated micro-cluster water is physically and chemically different than RO unprocessed water.

C. Simulated Distillation

Simulated distillations were carried out on RO water and unoxygenated micro-cluster water without oxygenation by West Coast Analytical Service, Inc. in Santa Fe Springs, Calif.

Simulated Distillation Test Results

| | RO Water | Unoxygenated Micro-cluster Water |
|---|---|---|
| Boiling Point range* | 98-100 | 93.2-100 |
| (deg. C.) | | |

*Corrected for barometric pressure.

These results show a significant lowering of the boiling temperature of the lowest boiling fraction in the unoxygenated micro-cluster water sample. The lowest boiling fraction for micro-cluster water is observed at 93.2° C. compared with a temperature of 98° C. for the lowest boiling fraction of RO water. This suggests that the process has significantly changed the compositional make-up of molecular species present in the sample. Note that lower boiling species are typically smaller, which is consistent with all observed data and the formation of micro-clusters.

D. Thermogravimetric Analysis

In this test, one drop of water was placed in a dsc sample pan and sealed with a cover in which a pin-hole was precision laser-drilled. The sample was subject to a temperature ramp increase of 5 degrees every 5 minutes until the final temperature. TGA profiles were run on both unoxygenated micro-cluster water and RO water for comparison.

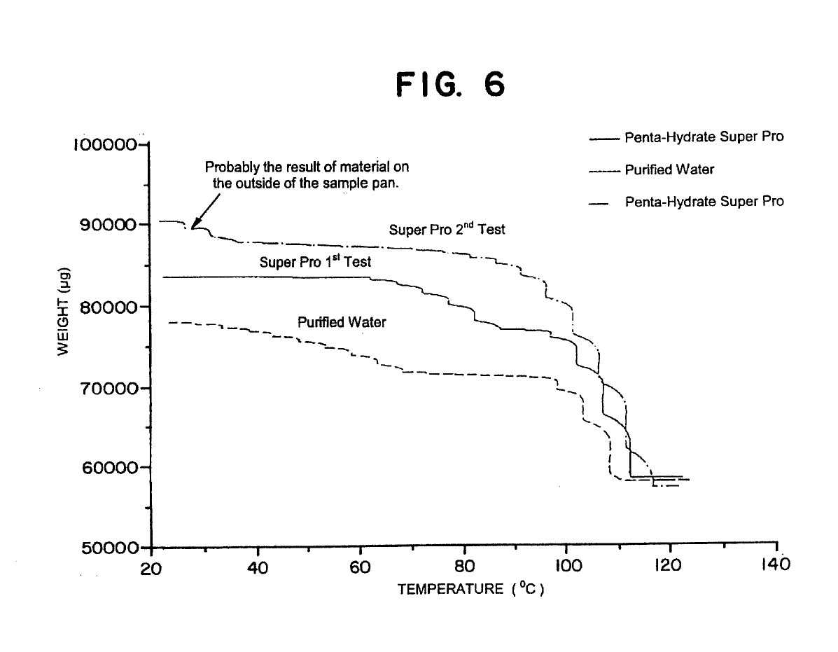

The TGA analysis was performed on a TA Instruments Model TFA2950TM by Analytical Products in La Canada, Calif. The TGA test results are shown in FIG. 6. Three test runs utilizing three different samples are shown. The RO water sample is designated, “Purified Water” on the TGA plot. The unoxygenated micro-cluster water was run in duplicate, designated Super Pro 1St test and Super Pro 2nd Test. The unoxygenated micro-cluster water and the unprocessed RO water showed significantly greater weight loss dynamics. It is evident that the RO water began losing mass almost immediately, beginning at about 40° C. until the end temperature. The micro-cluster water did not begin to lose mass until about 70° C. This suggests that the processed water has a greater vapor pressure between 40 and 70° C. compared to unprocessed RO water. The TGA results demonstrated that the vapor pressure of the unxoygenated micro-cluster water was lower when the boiling temperature was reached. These data once again show that the unoxygenated micro-cluster water is significantly changed compared to RO water. These data once again show that the unoxygenated micro-cluster water also shows more features between the temperatures of 75 and 100 +deg. C. These features could account for the low boiling fraction(s) observed in the simulated distillation.

E. Nuclear Magnetic Resonance (NMR) Spectroscopy

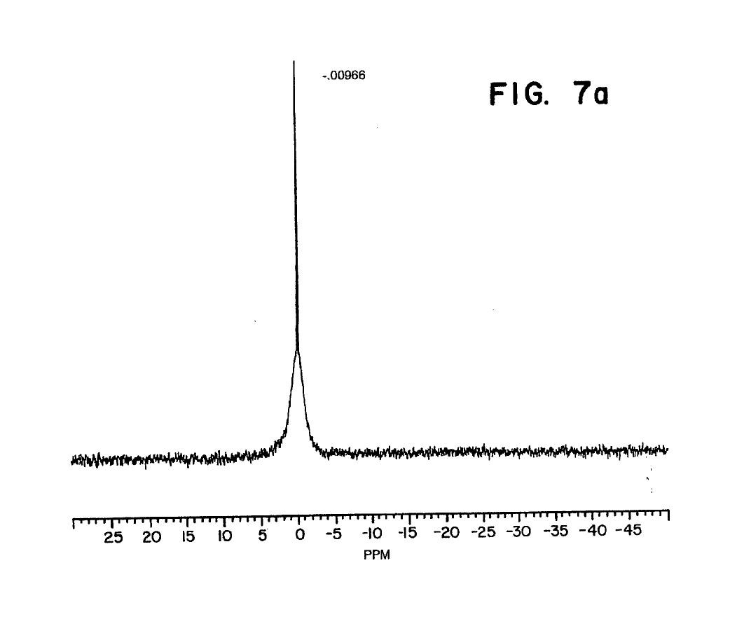

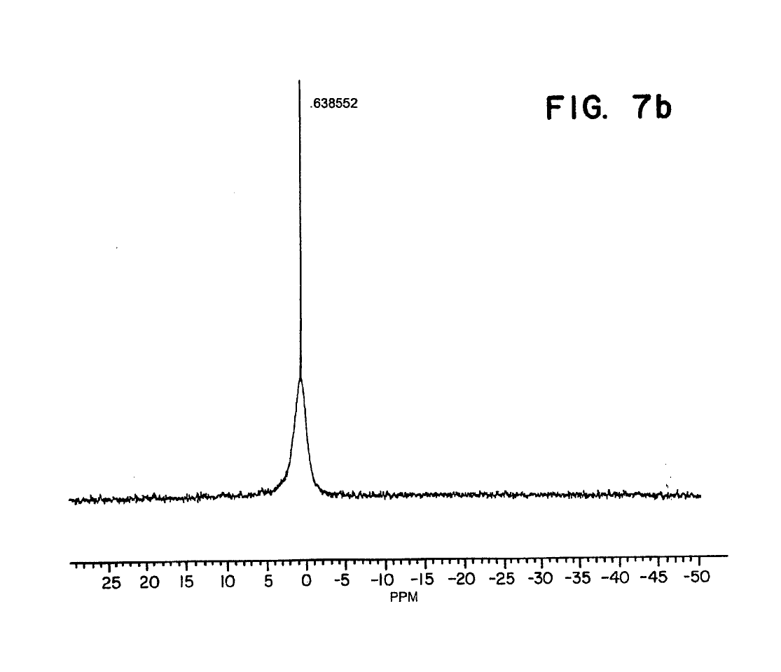

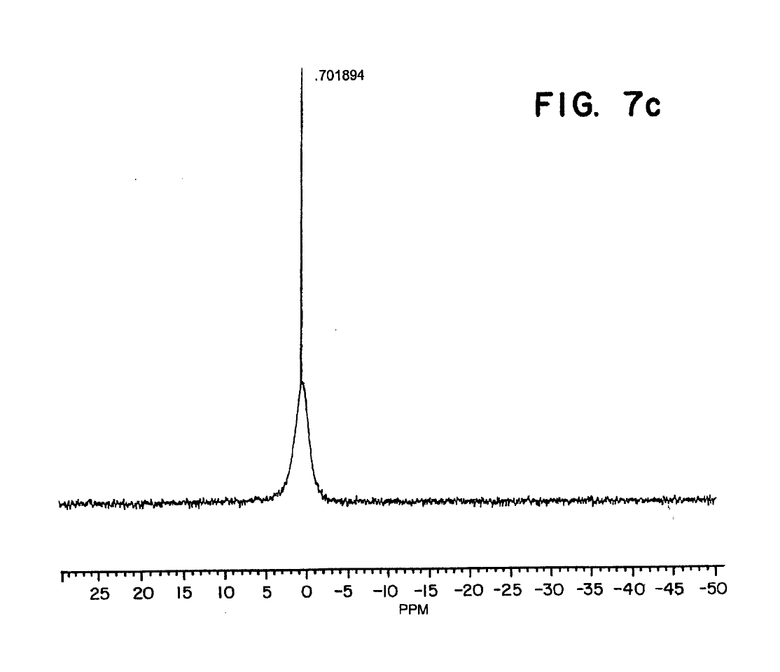

NMR testing was performed by Expert Chemical Analysis, Inc. in San Diego, Calif. utilizing a 600 MHz Bruker AM500υ instrument. NMR studies were performed on micro-cluster water with and without oxygen and on RO water. The results of these studies are shown in FIG. 7. In 17 O NMR testing a single expected peak was observed for RO water (FIG. 7 (a)). For micro-cluster water without oxygen (FIG. 7(b)), the single peak observed was shifted +54.1 Hertz relative to the RO water, and for the micro-cluster water with oxygen (FIG. 7(c)), the single peak was shifted +49.8 Hertz relative to the RO water. The shifts of the observed NMR peaks for the micro-cluster water and RO water. Also of significance in the NMR data is the broadening of the peak observed with the micro-cluster water sample compared to the narrower peak of the unprocessed sample.

FOOD OR EDIBLE MATERIAL AND BEVERAGES: PROCESSES, COMPOSITIONS, AND PRODUCTS: MODES OF CARRYING OUT THE INVENTION

General Description and Definitions

The practice of the present invention will employ, unless otherwise indicated, conventional food technology, food chemistry, food processing, organic- and biochemistry within the skill of the art. Such techniques for foods and beverages are fully explained in the literature. See, e.g. Potter, N. N. and Hotchkiss, J. H., Food Science, Fifth Edition, 1998, Aspen Publishers; Belitz, H. D. and Grosch, W. Food Chemistry, Second Edition, 1999, Springer; T. P. Coultate, Food: The Chemistry of Its Components, Fourth Edition, 2002, Royal Society of Chemistry; Owen R. Fennema, Food Chemistry, 3rd Edition, 1996, Marcel Dekker, Inc.; The Properties of Water in Foods ISOPOW 6, Edited by David S. Reid; 1998 Shafiur Rahman, Food Properties Handbook, 1995, Culinary and Hospitality Industry Publications Services; Brennan, J. G., Butters, J. R. et al., 1990, Food Engineering Operations, Chapman and Hall; Heldman, D. R., and Hartel, R. W., 1997, Principles of Food Processing, Chapman and Hall; Encyclopedia of Agricultural, Food, and Biological Engineering, 2003, Edited by: Dennis R. Heldman, Marcel Dekker, Inc.; Food Structure—Creation and Evaluation, 1987, eds. J. R. Mitchell and J. M. V. Blanshard, Woodhead Publishing Ltd.; Amorphous Food and Pharmaceutical Systems, 2002, ed. H. Levine, RSC Publishers; Ruan, Roger and Chen, Paul L., Water in Foods and Biological Materials, A Nuclear Magnetic Resonance Approach, 1998, Culinary and Hospitality Industry Publ. Services; Jose M. Aguilera and Stanley, David W., Microstructural Principles of Food Processing and Engineering, Second Ed., 2000, Culinary and Hospitality Industry Publ. Services; Functional Properties of Food Macromolecules, eds. J. R. Mitchell and D. A. Ledward, 1986, Elsevier Applied Science Publ.; Roos, Y. H., Phase Transitions in Foods, 1995, Academic Press. An extensive catalog of food science and technology reference books is available from American Technical Publishers, Ltd., Hitchin, Herts., SG4 0SX, England. Water structure and behavior, including water's role in the hydration of food molecules, is exhaustively set forth online at http://www.sbu.ac.uk/water/. The references or patents cited herein are incorporated to the extent possible for teachings which are relevant for supplementing the present disclosure.

The subject invention is directed to foods or edible materials and beverages, which have been hydrated with structured water. In one aspect, the invention comprises foods or edible materials and beverages which comprise structured water, and to structured ingredients or additives that are involved in preparing a structured or non-structured edible.

Another aspect of the invention involves the use of structured water in food or beverage processing, a process which involves a step of hydrating a food processing system by contacting structured water with at least one of the ingredients or products of the food processing system.

The invention is directed to the use of structured water as well as structured compositions for treating or perfecting a food material. In particular, the invention covers methods of using structured water in the various roles played by water including but not restricted to those set forth in the following table:

TABLE
Roles of Water in Food and Beverages

| | | | Quality |
|---|---|---|---|
| | | | Attribute |
| Role | Moisture Range | Mechanism of Effect | Affected |
| Solvent | All-excluding | Solution | All |
| | bound water | | |
| Reaction Medium | All-excluding | Facilitation of chemical change | All |
| | bound water | | |
| Reactant | All | Hydrolyzing agent | Flavor, texture |
| Antioxidant | Low | Hydration and precipitation of | Flavor, color, |
| | | metal catalysts, bonding to | texture, nutritive |
| | | peroxides and functional groups of | value |
| | | proteins and carbohydrates, | |
| | | promotes free radical | |
| | | recombination. | |
| Prooxidant | Medium | Reduction in viscosity increases | Flavor, color, |
| | | mobility of reactants and catalysts. | texture, nutritive |
| | | Swelling of solid matrices | value |
| | | exposing catalytic surfaces and | |
| | | oxidizable groups | |
| Structural- | All | Maintains the integrity of proteins | Texture and |
| intramolecular | | molecules | attributes |
| | | | affected by |
| | | | enzymes |
| Structural- | Low | Hydrogen bonding to surface | Viscosity |
| Intermolecular | | groups on macromolecules | |
| | | Hydrogen bonding to cross-linking | Texture - in |
| | | sites of macromolecules | dehydrated foods |
| Structural- | Medium and High | Influence on structure of | Rheological |
| intermolecular | | emulsions (i.e. binding to surface | properties of |
| | | lipids). Influence the interactions | emulsions and |
| | | and conformation of gel forming | textural |
| | | polysaccharides and proteins. | properties of |
| | | | gels. |

The solute hydration role of structured water in food processing is further characterized by the classifications of the types of water-solute interactions as set forth in the following table reproduced from Fennema, Food Science, 3rd Edition.

TABLE 3
Classifications of Types of Water-Solute Interactions

| | | Strength of interaction |
|---|---|---|
| | | compared to water-water |
| Type | Example | hydrogen bond^{a} |
| Dipole-ion | Water-free ion | Greater^{b} |
| | Water-charged group on | |
| | organic molecule | |
| Dipole-dipole | Water-protein NH | Approx. equal |
| | Water-protein CO | |
| | Water-side chain OH | |
| Hydrophobic hydration | Water + R^{c} → R(hydrated) | Much less (ΔG > 0) |
| Hydrophobic interaction | R(hydrated) + R(hydrated) → R₂ | Not comparable^{d} (>hydrophobic |
| | (hydrated) + H₂0 | interaction; (ΔG < 0) |

^{a}About 12-25 kJ/mol.
^{b}But much weaker than strength of single covalent bond.
^{c}R is alkyl group.
^{d}Hydrophobic interactions are entropy driven, whereas dipole-ion and dipole-dipole interactions are enthalpy driven.

The invention provides in general for structured products and compositions in any physical form, which are intended to be consumed via in whole or part via the oral cavity by human beings or animals. Further, structured water is included in the invention in any of its physical forms.

The scope of the present invention finds utility in the fields of food engineering, food chemistry, and food biology.

Food engineering involves food manufacturing, processing, packaging and preservation. Analogous to the roles of water, structured water, compositions thereof, and methods of processing foods that involve the structured water hydration methods described herein find applicability in fluid mechanics and mixing during extrusion, dough rheology, predicting diffusion of flavor compounds, understanding mechanism of expansion during extrusion, micro and macro structures of foods, baking and microwave processing, simultaneous heat and mass transfer during hybrid baking, and membrane-based technologies, as well as ice crystal size control during freezing, hot air jet impingement baking, health promotion through processed foods, food waste and by-product utilization, modified atmosphere packaging and smart packaging for microbial safety.

Food Chemistry applies chemical techniques, concepts and laws to determine the kinds and amounts of molecules in foods, their physical properties, and their chemical transformations during manufacture and storage. Structured water, compositions thereof, and methods of processing foods that involve the hydration methods described herein find applicability in a broad range from the analysis of food components to measurements of the molecular mobility of amorphous solids; chemical transformations of lipids, carbohydrates, and proteins, processing techniques such as extrusion, control of antimicrobial or ice-nucleating proteins; spectroscopic, mechanical, and thermal techniques for characterizing how the physical properties of amorphous, non-crystalline, solids modulate their chemical and physical properties and thus their shelf-life and stability.

### DEFINITIONS

The meaning to be given to the various “art” terms appearing in the classes of patentable subject matter set forth herein, but which have not been included in the glossary below, is the same as that generally accepted or in common usage.

The terms “water” and “structured water” and “microclustered water” are used interchangeably. The subject matter and scope of the “structured” inventions is informed by and analogous to the meaning of the term “water” as derived from the context of its use herein (U.S. Pat. No. 6,521,248).

The terms “food” and “edible” will be used synonymously and interchangeable herein. Each ingredient or additive used in a food processing system, whether naturally occurring as a product of nature or synthetically produced, that becomes a part of an edible composition, or treats an edible composition or is either disclosed or claimed as being edible, is to be regarded as being edible.

Food or edible material includes beverages, as defined broadly in Class 426. By way of example, but not limitation, subclass 590 involves liquid intended to be drunk or a concentrate upon which the addition of aqueous material forms a liquid intended to be drunk. Subclasses 569 (for beverages which form a foam) and 580 (for lacteal containing beverages) are included. Subclass 592 covers subject matter wherein the product contains ethyl alcohol. A detailed list of beverages, their definitions, and classifications which refer to the scope of subject matter within each is found in the U.S. Manual of Patent Classification, which is obtained from the United States Patent and Trademark Office.

Compositions which comprise structured water are referred to herein as “micro-clustered compositions.” The adjective “micro-clustered” modifies nouns which denote compositions of matter (e.g. substances, additives, ingredients) and indicates that the modified composition of matter comprises micro-clustered water as a result of otherwise being hydrated at least in part by structured water. The acronym MCW stands for structured water.

A food processing system, in one aspect, involves breaking down the inherent structures within food materials or ingredients to a varying extent, and is therefore concerned with all aspects of food—the chemical and physical properties of food and its constituents, the processing and production of food, and the packaging and marketing of food, which represent components of a food processing system. Food quality—texture, flavor release, nutrient availability, moisture migration, and microbial growth—are influenced and determined by the formation, stability and breakdown of structures within foods. Each ingredient or additive used in a food processing system, whether naturally occurring as a product of nature or synthetically produced, that becomes a part of an edible composition, or treats an edible composition or is either disclosed or claimed as being edible, is to be regarded as being edible. Food processing involves conversion of raw materials and ingredients into a consumer food or edible product. Food processing includes any action that changes or converts raw plant or animal materials into safe, edible, and more palatable foodstuffs. Improvement of storage or shelf life is another goal of food processing.

HYDRATION CHEMISTRY IN FOOD PROCESSING

The present invention is directed to the use of structured water in food processing. Water in combination with carbohydrates, lipids, and proteins, represents one of the main components of foods. Accordingly, the invention is directed to methods of achieving combinations of structured water with carbohydrates, lipids and proteins in food processing systems.

Water's hydration properties depend, in part, on its clustering (Water structure and behavior, including water's role in the hydration of food molecules, is exhaustively set forth online at http://www.sbu.ac.uk/water/; and The Properties of Water in Foods ISOPOW 6, Edited by David S. Reid). Structured water's hydration properties toward biological macromolecules (particularly proteins and nucleic acids) is a determinant of their three-dimensional structures, and hence their functions, in solution.

Structured water is used in processing of foods to improve texture, mixing, and flowing properties, and functionality. MCW is also involved in a number of interactions with other components of foods. These interactions may contribute to the molecularly disordered, amorphous state, e.g., in low moisture foods. In amorphous food systems, the glass transition is the characteristic temperature range over which a stiff material softens and begins to behave in a leathery manner. This change is a temperature-, time- (or frequency) and composition-dependent, material specific change in physical state, from a “glassy” mechanical solid to a “rubbery” viscous fluid

MCW plasticizes amorphous materials and enhances crystallization. The plasticizing effect of MCW gives rise to an increase in the molecular mobility that facilitates the arrangement of molecules and possibly enhances enzymatic reactions. The availability of MCW is a factor affecting rates of enzymatic reactions in amorphous food systems. Food materials are significantly plasticized by MCW. At increasing MCW contents, the materials also have higher water activities. Plasticizers are used to improve flexibility and workability of polymers as well as reduce viscosity.

Enzymatic reactions are often responsible for deleterious changes in low moisture foods. The rates of these changes may be related to changes in the physical state such as the glass transition. Water, in its normal and in its structured form, is the most important plasticizer of food materials. Water and other plasticizers also affect rates of enzymatic reactions. Food systems including carbohydrates, such as sugars, are very susceptible to crystallization even at reduced moisture level. Upon crystallization, the sorbed water may be expelled to the food materials changing the moisture level of the food systems and possibly affect rate of enzymatic reactions. Water's effect as a plasticizer and its effects on the rate of enzymatic reactions as a function of the texture of foods are important factors on maintaining quality and shelf life of low moisture food systems.

The physical state of food systems depends on the amount of water and other plasticizers, and the types of molecular interactions that involve all the components.

“Water binding” and “hydration” refer to the tendency of water to associate with various degrees of tenacity to hydrophilic or hydrophobic substances. Hydrophilic solutes (i.e. solutes or structures possessing hydrophilicity) interact with water with greater or comparable strength to water-water interactions whereas hydrophobic solutes (i.e. solutes or structures possessing hydrophobicity) only weakly interact with water with strength far less than water-water interactions.

Methods for determining the hydration of molecular species which comprise food and the effects of hydration on food qualities are well known in the art (Shafiur Rahman, Food Properties Handbook, 1995, Culinary and Hospitality Industry Publications Services).

Water competes for hydrogen bonding sites with intramolecular and intermolecular hydrogen bonding and is a major determinant of the conformation of carbohydrates, proteins, and lipids.

The Contribution of Water to Protein Structure

Hydration is very important for the three-dimensional structure and activity of proteins. Indeed, enzymes lack activity in the absence of water. In solution they possess a conformational flexibility, which encompasses a wide range of hydration states, not seen in the crystal or in non-aqueous environments. Equilibrium between these states will depend on the activity of the water within its microenvironment; i.e. the freedom that the water has to hydrate the protein. Thus, protein conformations demanding greater hydration are favored by more reactive water (e.g. high density water containing many weak bent and/or broken hydrogen bonds) and ‘drier’ conformations are relatively favored by lower activity water (e.g. low-density water containing many strong intra-molecular aqueous hydrogen bonds).

The folding of proteins depends on the same factors as control the junction zone formation in some polysaccharides; i.e. the incompatibility between the low-density water (LDW) and the hydrophobic surface that drives such groups to form the hydrophobic core. In addition, water acts as a lubricant, so easing the necessary hydrogen bonding changes. Water molecules can bridge between the carbonyl oxygen atoms and amide protons of different peptide links to catalyze the formation, and its reversal, of peptide hydrogen bonding. The internal molecular motions in proteins, necessary for biological activity, are very dependent on the degree of plasticizing, which is determined by the level of hydration. Thus internal water enables the folding of proteins and is only expelled from the hydrophobic central core when finally squeezed out by cooperative protein chain interactions. The position of the equilibrium around enzymes has been shown to be important for their activity with the enzyme balanced between flexibility and rigidity.

Protein folding is driven by hydrophobic interactions, due to the unfavorable entropy decrease forming a large surface area of non-polar groups with water. In protein denaturation, water is critical, not only for the correct folding of proteins but also for the maintenance of this structure. The free energy change on folding or unfolding is due to the combined effects of both protein folding/unfolding and hydration changes.

Peptides and proteins play roles in foam, gels, emulsifying, flavor precursors, flavor compounds, and as enzymes. These properties are derived from the physico-chemical properties of amino acids and proteins. As described above, hydration of proteins plays an important role in the functionality of proteins, including binding of food components by proteins, gelation, swelling, production of dough, emulsifying, and foaming. The catalytic activity of enzymes and the regulation of enzyme reactions requires a knowledge of protein hydration and the aqueous microenvironment. Enzyme classes important to food processing include oxidoreductases, transferases, hydrolases, lyases, isomerases, and ligases. Water activity plays a key role in the regulation of enzyme reactions.

Even in low moisture foods, enzymatic changes can occur despite the low water activity. The occurrence of these reactions reduces the storage stability of products. Water can play several different roles in food systems: (1) Water may act as second substrate. It is well known that the spatial structure of protein, which governs their functional properties, is stabilized by several kinds of interactions that include hydrogen bonds, between polar groups or between polar groups and water, and hydrophobic bonds associated with the structure of water around the protein molecule; (2) As disrupter of hydrogen bond and consequently contributing to the alteration of protein structure; (3) As a solving medium facilitating the diffusion of reactants; (4) As a reagent in the case of hydrolysis reaction.

As a summary, enzyme activity depends on water-enzyme, water-substrate and water-matrix interactions. Also, matrix-substrate and matrix-enzyme interactions may be involved.

Finally, the occurrence of enzyme-catalyzed reactions in low moisture systems requires a certain quantity of water in order to facilitate both mobility and diffusion of reactants. This quantity may change according to the characteristics of the enzyme and the solubility and molecular size of the substrate.

Enzymatic reactions involve the interaction of an enzyme with a substrate where often water is associated either as a solvent or a second substrate. The hydrolysis of sucrose requires that invertase is in contact with the hydrolytic bond of sucrose. If the system is dehydrated, the addition of water is necessary to restore the activity of the enzyme. There is, therefore, a requirement of mobility of the components. Water has to diffuse through the system, the enzyme may exert a certain mobility to reach the hydrolytic bond, or the substrate needs to move toward the active site of the enzyme. The rate of enzymatic reactions has to be dependent on the rate at which those motions take place, which depends in turn on the structure of the matrix of the systems. The presence of polysaccharides in viscoelastic liquid for example has been shown to cause entanglement of the polysaccharide chain and restrict diffusion of water molecules.

In water restricted systems, it could be assumed that mobility would be limited. The activity of the enzyme would be dependent on its closeness to the substrate. The enzyme should, therefore, be distributed in such a way that it is available in the vicinity of the substrate. Poor miscibility could also lead to reduced reaction rates since it may reduce interactions between molecules. Composition, structure, and environmental conditions including moisture content, temperature, and pH, determine the physical state and the dynamics of the systems.

Whitaker (Principles of Enzymology for the Food Sciences,1994, 2nd ed., Marcel Dekker, Inc.; and Chapter 7 in Fennema, O. R. Food Chemistry, 3rd ed., 1996, Marcel Dekker, Inc.) elucidated the role of water on enzyme activity. Water plays at least four important functions in all enzyme-catalyzed reactions: (1) folding of the protein, (2) acting as a transport medium for the substrate and enzyme, (3) hydration of the protein, and (4) ionization of prototropic groups in the active sites of the enzyme.

Nucleic Acid Hydration

Hydration is very important for the conformation and utility of nucleic acids. Hydration is greater and more strongly held around the phosphate groups, due to their rather diffuse electron distribution, but more ordered and more persistent around the bases with their more directional hydrogen-bonding ability. Because of the regular structure of DNA, hydrating water is held in a cooperative manner along the double helix in both the major and minor grooves. The cooperative nature of this hydration aids both the zipping (annealing) and unzipping (unwinding) of the double helix.

Nucleic acids have a number of groups that can hydrogen bond to water, with RNA having a greater extent of hydration than DNA due to its extra oxygen atoms (i.e. ribose O2′) and unpaired base sites. In DNA, the bases are involved in hydrogen-bonded pairing. However even these groups, except for the hydrogen-bonded ring nitrogen atoms (pyrimidine N3 and purine N1) are capable of one further hydrogen-bonding link to water within the major or minor grooves. Such solvent interactions are key to the hydration environment, and hence its recognition, around the nucleic acids and directly contributes to the DNA conformation.

Water Activity

Water activity has been an extremely useful tool in food science and technology. It is useful in relating to dynamics of moisture transfer and mapping of regions of microbial growth, physical changes and chemical reactions. Controlling water activity in a food processing system is critical for achieving a desired food stability, and for predicting a product's shelf life.

Water activity, a_{w}, is a property of water in a material. In the mid 1970s, water activity came to the forefront as a major factor in understanding the control of the deterioration of reduced moisture and dry foods, drugs and biological systems. It was found that the general modes of deterioration, namely physical and physicochemical modifications, microbiological growth, and both aqueous and lipid phase chemical reactions, were all influenced by the thermodynamic availability of water as well as the total moisture content of the system. It is the difference in the chemical potential of water between two systems that results in moisture exchange and above a certain chemical potential as related to the aw of a system there is enough water present to result in physical and chemical reactions.

The physical structure of a food or biological product, important from both functional and sensory standpoints, is often altered by changes in water activity due to moisture gain or loss. For example, the caking of powders is attributed to the amorphous-crystalline state transfer of sugars and oligosaccharides that occurs as water activity increases above the glass transition point. This caking interferes with the powder's ability to dissolve or be free flowing and phase transitions can lead to volatile loss or oxidation of encapsulated lipids. The desirable crispiness of crackers, dry snack products such as potato chips, and breakfast cereals is lost if a moisture gain results in a water activity elevated above a threshold, again above the glass transition. Conversely, raisins and other dried fruits may harden due to the loss of water associated with decreasing water activity. Thus, raisins or other fruits in breakfast cereals are sugar coated to reduce the moisture loss rate or are modified with glycerol to reduce the water activity thereby preventing moisture loss. These procedures inhibit the net moisture transfer rate from the raisins to the cereal, therefore maintaining the cereal's crisp nature and the softness of the fruit pieces in the presence of a chemical potential driving force. Finally, as a_{w}, increases, the permeability of packaging films to oxygen and water vapor increases, due to swelling in the rubbery state.

Like physicochemical phenomena, the growth and death of microorganisms are also influenced by water activity. It has been repeatedly shown that each microorganism has a critical water activity below which growth cannot occur. For example, Aspergillus parasiticus does not grow below a certain water activity while the production of aflatoxin, a potent toxin, from the same organism is inhibited below a slightly higher water activity. For growth or toxin production to cease, key enzymatic reactions in the microbial cell must cease. Thus, the lowering of water activity inhibits these biochemical reactions, which in turn restricts microbial functioning as a whole. With spores, the lower the water activity, the more resistant they are to heat kill.

Microbially stable dry foods generally are defined as those with a water activity below a defined level, below which no known microbe can grow.

Water activity has been shown to influence the kinetics of many chemical reactions. Except for lipid oxidation reactions where the rate increases as water activity decreases at very low water activities, the rates of chemical reactions generally increase with increasing water activity.

When water interacts with solutes and surfaces, it is unavailable for other hydration interactions. The term ‘water activity’ describes the equilibrium amount of water available for hydration of materials; a value of unity indicates pure water whereas zero indicates the total absence of water molecules. It has particular relevance in food chemistry and preservation.

Changes in water activity may cause water migration between food components. Foods containing macroscopic or microstructural aqueous pools of differing water activity will be prone to time and temperature dependent water migration from areas with high water activity to those with low water activity. a useful property used in the salting of fish and cheese but in other cases may have disastrous organoleptic consequences. Such changes in water activity may cause water migration between food components. Foods with lower water activity will tend to gain water, those with higher water activity tend to lose water.

Control of water activity (rather than water content) is very important in the food industry as low water activity prevents microbial growth (increasing shelf life), causes large changes in textural characteristics such as crispness and changes the rate of chemical reactions (increasing hydrophobe lipophilic reactions but reducing hydrophile aqueous-diffusion-limited reactions).

Free moisture has been identified in food art by the term water activity. Water activity is defined as the ratio of the vapor pressure of water in an enclosed chamber containing a food to the saturation vapor pressure of water at the same temperature. Water activity is an indication of the degree to which unbound water is found and, consequently, is available to act as a solvent or to participate in destructive chemical and microbiological reactions.

Highly perishable foodstuffs have a_{w}>0.95. Growth of most bacteria is inhibited below about a_{w}=0.91; similarly most yeasts cease growing below a_{w}=0.87, and most molds cease growing below a_{w}>0.80. The absolute limit of microbial growth is about a_{w}=0.6. As the solute concentration required to produce a_{w}<0.96 is high (typically>1 molal), the solutes (and surface interactions at low water content) will control the structuring of the water within the range where a_{w}, knowledge is usefully applied.

Many food preservation processes attempt to eliminate spoilage by lowering the availability of water to microorganisms. Reducing the amount of free moisture or unbound water also minimizes other undesirable chemical changes, which can occur in foods during storage. The processes used to reduce the amount of unbound water in foods include techniques such as concentration, dehydration, and freeze-drying. These processes often require intensive expenditure of energy and are not cost efficient.

Control of water activity can be used successfully in achieving stability of foods, in prediction of moisture transfer between regimes in a multi-component food, for the prediction of water vapor transfer through food packaging and the prediction of the final water activity of a mixture of components including dissolved species.

Molecular Mobility. The molecular mobility (Mm) approach is a recent development in food science designed to explain how freezing and drying change the storage stability of foods and is an alternative and complementary method to water activity (a_{w}) ideas.

Most food materials do not form crystalline structures. To join in a crystal, the molecule in solution must slot into an existing lattice, rather like a jigsaw piece, it can only fit in at one orientation. Molecules rotate and flex in solution but they must be able to do so fast enough to form crystals before all the water leaves and movement stops. In relatively slow drying operations of small molecules crystals may have a chance to form: table sugar and salt are largely crystalline. However, large slow moving molecules or fast drying operations do not provide time for the crystals to grow and practically, in most cases crystals do not form. Instead, the solution becomes very viscous and eventually behaves like a rubber. If more water is removed the rubber becomes more and more viscous until at a critical point mobility effectively stops and the material can be considered a glass. Both glassy and rubbery materials are described as amorphous solids. Freezing can be considered a very similar process to drying. Water crystallizes as a pure ice, which takes no part in the solvation of the food material. As a food is frozen ice crystals form leaving the food in an increasingly dehydrated environment.

In each case the key parameter is molecular mobility—the capacity of the molecules present to move. Molecular mobility increases with temperature (the more thermal energy the molecules have the faster they move) and the concentration of small molecules (almost always water which acts as a molecular level lubricant or plasticizer). Drying lowers the moisture content and hence the molecular mobility of the solute. Freezing also lowers the water content (ice crystals form) but additionally the cooling reduces the thermal energy of the food molecules and therefore their mobility.

The molecular mobility of a material is inversely related to its viscosity (if the molecules don't move much the liquid is thicker) and viscosity affects the rate of diffusion limited reactions. For a reaction between two molecules to occur, the molecules must first collide and then have enough thermal energy to overcome the activation energy barrier to reaction.

The two technological approaches to getting food into a glassy state are freezing and drying. The molecular mobility approach is a novel complement to the a_{w} method of understanding the role of water in food spoilage. In general molecular mobility analysis is better for diffusion limited reactions, frozen foods and physical changes, they are about equal for understanding crispness and stickiness, and a_{w} is preferred for dried foods and non-diffusion limited processes. Some properties and behavioral characteristics of food that are dependent on molecular mobility are shown in the following table:

TABLE 7
Some Properties and Behavioral Characteristics of Foods That Are Governed by
Molecular Mobility (Diffusion-Limited Changes in Products Containing Amorphous Regions)

| Dry or Semidry Foods | Frozen Foods |
|---|---|
| Flow properties and stickiness | Moisture migration (ice crystallization, |
| Crystallization and recrystalization | formation of in-package ice) |
| Sugar bloom in chocolate | Lactose crystallization (“sandiness” in frozen |
| Cracking of foods during drying | desserts) |
| Texture of dry and intermediate moisture foods | Enzymatic activity |
| Collapse of structure during secondary (desorption) | Structural collapse of amorphous phase during |
| phase of freeze-drying | sublimation (primary) phase of freeze- |
| Escape of volatiles encapsulated in a solid, | drying |
| amorphous matrix | Shrinkage (partial collapse of foam-like frozen |
| Escape of volatiles encapsulated in a solid, | desserts) |
| amorphous matrix | |
| Enzymatic activity | |
| Maillard reaction | |
| Gelatinization of starch | |
| Staling of bakery products caused by retrogradation | |
| of starch | |
| Cracking of baked goods during cooling | |
| Thermal inactivation of microbial spores | |

Glass Transition and Water Activity: Physical Properties of the Rubbery and Glassy State and Food Stability

Phase and state transitions. Phase transitions are changes in the state of materials occurring at well-defined transition temperatures—melting (solid to liquid)—crystallization (liquid to solid)—vaporization (liquid to gas)—condensation (gas to liquid). A number of materials, including foods, are noncrystalline but may exhibit properties of solids or liquids. Noncrystalline materials are amorphous materials, i.e., their molecules are arranged randomly. Amorphous materials are often supercooled liquids or solids. Supercooled liquids are often called “rubbers” and the solids are “glasses.” Transformation between the supercooled liquid and solid states occurs over a temperature range, and the transition is known as the “glass transition.”

Glass transition is typical of inorganic and organic amorphous materials, including such food components as sugars and proteins. A number of material properties change over the glass transition temperature range.

Water Plasticisation. Water is the most important solvent, dispersion medium, and plasticizer in biological and food systems. Plasticization and its modulating effect on temperature location of the glass transition is a key technological aspect of synthetic polymer technology where a plasticizer is defined as a material incorporated in a polymer to increase the material's workability, flexibility, or extensibility. The plasticizing effect is usually described by the dependence of the glass transition temperature on either the weight, the volume, or molar fraction of water. Water plasticization can be observed from the decrease in the glass transition temperature with increasing water content which may also improve the detectability of the transition. Both carbohydrates and proteins are significantly plasticised by water, i.e., water acts as a softener, depressing the glass transition temperature. The glass transition of water, i.e., solid noncrystalline water, is at about −135° C. At high water contents the glass transition approaches that of water. The detectability of the glass transition often increases with increasing water content—decreasing broadness of the transition—increasing change in heat capacity over the transition temperature range.

Glass Transitions in Foods.

Understanding the glass transition and its relationships with physicochemical changes is very important for predicting the state and the behavior of food during processing, distribution, and storage.

The glass transition curve is a critical factor needed to understand physical changes of food. By way of example, in a cereal food processing system, it is important to recognize that if textural changes in a cereal system can be correlated with a glass transition, and the state diagram for the cereal food is known, then the processing and environmental conditions can be controlled such that the desired state for the food is achieved and is also retained during distribution and storage.

The amorphous state of nonfat food solids is typical of low moisture and frozen foods. Typical amorphous, glassy or rubbery foods are—dried fruits and vegetables—extruded snacks and breakfast cereals—hard sugar candies—free flowing powders—freeze-concentrated solids in frozen foods. The glass transition of food materials can be observed from a change in heat capacity, from a change in mechanical properties, and from a change in dielectric properties. The temperature range of the glass transition is dependent on the food material—low molecular weight food components, e.g., sugars, show a clear glass transition occurring over a temperature range of about 20° C.—high molecular weight food components, e.g., proteins and starch, show a wide glass transition.

The glass transition temperature range is a specific property of each material.

Carbohydrates. Sugars have clear glass transitions. The glass transition temperatures of sugars increase with increasing molecular weight.

Proteins. Amorphous proteins are important structural biopolymers. Amorphous proteins are important structural components of cereal foods, e.g., gluten in bread. The glass transitions of proteins are often difficult to determine calorimetrically due to a small change in heat capacity and broadness of the transition.

Frozen materials. Ice formation during freezing results in freeze-concentration of solutes. The extent of freeze-concentration is dependent on the solutes and temperature. At low temperatures the freeze-concentrated solutes with unfrozen water vitrify, i.e., the materials contain a crystalline ice phase and a noncrystalline, glassy solute phase. Some solutes may crystallize, e.g., NaCl solution—freeze-concentrated sugars and foods often vitrify. Maximally freeze-concentrated solutions show glass transition at an initial concentration dependent temperature above which ice melting has an onset temperature.

In defining the relationship between moisture content and chemical reaction rates, polymer sciences provides theories of glass transition and water activity to explain the textural properties of food systems and the changes which occur during food processing and storage such as stickiness, caking, softening and hardening. Food may be a complicated mixture of lipids, polysaccharides, sugars, proteins, etc. existing in different phases. There may be local differences in water content affecting the glass transition.

By way of examples, if an amorphous material exists in the glassy state, it is hard and brittle, e.g. for cereals it would represent a crisp product. In the rubbery state the material is soft and elastic, for a fried snack or cereal this would represent an undesirable soggy state.

Thus glass transition theory provides a clearer approach to understanding the physical and texture changes of crisp cereals or snacks as water content increases. Texture is an important sensory attribute for many cereal based foods and the loss of desired texture leads to a loss in product quality and a reduction in shelf life. Saltine crackers, popcorn, puffed corn curls, puffed rice cakes, and potato chips lost crispness if the water activity exceeded a threshold. Crispness is attributed to intermolecular bonding of starch forming small crystalline-like regions when little water was present. These regions require force to break apart which gives the food a crisp texture. Above a certain water activity, the water was presumed to disrupt these bonds allowing the starch molecules to slip past each other when chewed. The crisp perception of dry cereal snacks was the result of sounds generated when chewed which diminished as the water activity was increased. Loss of crispness is well explained by the transition from the glassy to the rubbery state.

Caking is another property that can be related to the glass transition. When a sugar is in solution and is dried, it is in the amorphous glassy state and the powder is free flowing. At a high enough moisture or temperature, the material can enter the rubbery state. In the rubbery state, dried amorphous sugars tend to crystallize rapidly because of increased diffusion rates above a certain temperature, a condition resulting in undesirable caking, which inhibits free flow. Caking follows characteristic the steps for particles that are wetted by water vapor.

The choice of ingredients and level of plasticizers such as water and other small molecular weight components influences the glass transition temperature of a food product. In general, as the molecular weight of a polymer increases within a homologous series, the glass transition temperature increases. The addition of plasticizers decreases the glass transition temperature.

Effects of Water on Diffusion in Food Systems.

A number of operations in food processing, and the stability of stored foods, are affected by diffusional properties of food systems, which include the foods themselves, their immediate environment within a package, and any barriers (packaging or coating) used with the foods. Water content and “water activity” affect these diffusional properties dramatically, by plasticizing food and/or packaging polymers and affecting glass transition temperatures of components, and in some cases, water may serve as an internal transport medium.

The term “additive,” as used herein refers to a substance or a mixture of substances used primarily for purposes other than its nutritive value and added to a food in relatively small amounts to (1) impart or improve desirable properties (2) or suppress undesirable properties, and (3) may become a part of the food or be transitory in nature. (Compare ingredient below which in some instance may be an additive).

The term “basic ingredient,” as used herein means a principal constituent (except added water) of a composition considered to be the fundamental part and by which the composition is usually identified. Usually the basic ingredient constitutes the major portion of the composition, e.g., chocolate milk-milk is the basic ingredient. In those instances wherein a plurality of percentages of the ingredients are given that ingredient which constitutes 50 of the total composition (excluding added water) is considered to be the basic ingredient. The 50% may be determined by summing like ingredients, e.g., lactose, whey and butter fat are all lacteal derived.

“Carbohydrate” refers to a compound, the monomeric units of which contain at least five carbon atoms, and their reaction products wherein the carbon skeleton of carbohydrate unit is not destroyed. Alcohols and acids corresponding to carbohydrates, such as, sorbitol ascorbic acid, or mannonic acid are not considered as being carbohydrates.

The term “dry” refers to products which are as a complete product free or relatively free from water and under normal ambient conditions involve such characteristics, but not necessarily each and every one, as free flowing, dry to the touch, nontacky or sticky, nonadhesive, granular, powder, tablet, flake, flour, meal, particulate, pellet, finely divided, etc.

The term “ferment” refers to any enzyme or any living organism that is capable of causing or modifying a fermentation.

The term “ingredient” refers to a component part (usually a major one) of mixture that goes to make a food.

Ingredient or additive does not include packaging materials, containers, paper products, etc. or any other material which would not reasonably be regarded as being edible. However, in some instances, additive may be an ingredient.

“Isolated triglyceridic fat or oil” refers to fat or oil (as defined below) that is free of any of the plant or animal tissue from which it is derived.

“Package” refers to a mercantile combination of an edible material fully encased, encompassed, or completely surrounded by a solid material.

“Tissue” means material containing a certain amount of the original animal or plant as against an extract, which is considered to be devoid of original cellular structure. Included within the term are materials, which are chopped, cut, comminuted, pulverized, milled, slice, etc.

“Triglyceridic fat or oil” refers to esters of glycerol and a higher fatty acid (i.e., a monocarboxylic acid containing an unbroken chain of at least 7 carbon atoms bonded to a carbonyl group) wherein the three available hydroxyl functions of the glycerol are esterified by a same or different fatty monocarboxylic acid. Triglycerides are the chief constituents of the naturally occurring fats and oils.

Included in the invention are foods or edible products which , with a focus on water, could be classified as follows:

TABLE I
Classification of Food Products According to a Water
Content and Type of Appropriate Physico-Chemical Approach

| Physical State | Product Examples | Physico-Chemical Treatment |
|---|---|---|
| Dilute solutions/ | Drinks, soups | Equilibrium thermodynamics, |
| dispersions | | refer to Henry's law |
| Semi-dilute | Purees, jellies | Polymer chemistry, chain |
| solution/dispersion | | entanglement, sol-gel |
| (high moisture | | transformations |
| content) | | |
| Solids (high | Fish, vegetable, | Biophysical chemistry, colloid |
| moisture) | meat, ice cream | science |
| (intermediate | Preserves, sausages | Materials science |
| moisture) | | |
| (low moisture) | Dried products, | Materials science, glass/ |
| | cereals | rubber transitions |

The following discussion sets forth physical-chemical principles used by those skilled in the art of food science for formulating edibles and ingredients.

Colloids and Rheology

Colloids are dispersions of small particles of one phase (the disperse phase) in a second, continuous phase. Colloids occur widely in foods. The study of colloids is essentially the study of the physical interactions between the surface of the particles in the disperse phase and between the continuous phase and the disperse phase. Rheology is the study of materials when deformed.

Many foods are colloidal and complex in nature with the continuous phase being in the form of a true solution and there being more than one disperse phase. Milk has a continuous phase comprising polysaccharides, electrolytes and proteins in aqueous solution and disperse phases comprising both liquid fats and solid protein.

TABLE
Types of colloid

| | | Continuous | |
|---|---|---|---|
| Type | Disperse phase | phase | Example |
| Aerosol, Smoke | Liquid | Gas | smoke |
| Fog, mist aerosol | Solid | Gas | exhaled breath |
| Foam | Gas | Liquid | Whipped cream, |
| | | | beaten eggs. |
| Emulsion | Liquid | Liquid | Milk, Mayonnaise |
| Sol, Colloidal | Solid | Liquid | Cloudy beer, milk, |
| solution, gel, paste | | | gelatin, tomato paste |
| Solid foam | Gas | Solid | Ice cream, Meringue |

Emulsions and Surface Activity.

Emulsions are colloids where both disperse and continuous phases are liquid and are the most common type of food colloid. In the case of foods, they usually involve an oil phase and an aqueous phase and may be of two types:

oil in water (o/w) emulsions where the disperse phase is the oil

water in oil (w/o) emulsions where the disperse phase is the oil.

The phases in a emulsion may be exchanged by a process known as phase inversion. A common example of phase inversion in foods is butter making where cream is converted to butter by a process involving concentration and agitation. Once a sufficient oil concentration has been achieved, the agitation brings about a conversion of the o/w emulsion of cream to the w/o emulsion of butter. In the process, the oil concentration is further increased by the elimination of more aqueous phase as buttermilk. In general terms, the more stable form is determined by concentration.

Emulsifiers and Stabilizers

The process of forming an emulsion usually involves vigorous agitation to break up the oil into small droplets. Emulsion formation is assisted by the addition of emulsifiers, which help the break up process by reducing interfacial tension, thus these are usually surfactants. Common emulsifiers include detergents, glycerol mono stearate and lecithin.

Once the emulsion is formed, then it must be maintained which is the role of stabilizers. Emulsifiers can perform a stabilization role due to the electrostatic interactions between the hydrophilic portion of the molecule. However this may not be enough and stabilizers may also needed. Stabilization may be achieved by the addition or presence of macromolecules in the system. These may have two effects.

They may form a layer on the surface of the oil droplets which prevents the droplets meeting as a result of stearic hindrance. Insoluble proteins, such as casein in milk often perform this function.

They may dissolve in the continuous phase and increase its viscosity. In foods, for example, polysaccharides are often used for this purpose. Polysaccharide gums such as xanthan and carrageenan gums can produce substantial increases in viscosity on addition of small quantities as a consequence.

The breakdown of colloids involves particles coming together under the influence of the attractive forces and forming larger particles. There are various terms for this process depending on the exact nature of the process.

Flocculation is a loose association of particles which is relatively easily broken up and the phases redispersed

Coagulation is a more strongly bound collection of particles. A Coagulated disperse phase is not readily redispersed as inter-particle attraction is much stronger than in flocculation.

Coalescence is when particles merge to form a single larger particle.

The first two definitions are somewhat loose and the two terms are sometimes used interchangeably. In general, flocculation occurs if there is a lowering of the total surface free energy as a consequence.

Coalescence

Coalescence is the combining of two particles to form a single larger particle. The key distinction is that flocs and coagulated particles retain a distinct identity, but this is not the case with coalescence.

Coalescence is possible with both liquid and solid particles but is most common with liquids. The process involves a thinning of the continuous phase film between the particles until all the continuous phase has been expelled and the two particles merge.

Ostwald Ripening

If the disperse phase has any significant solubility in the continuous phase, the phenomenon called Ostwald ripening may occur. Owing to surface tension effects, small particles are generally more soluble than large particles. As a consequence, large particles tend to grow at the expense of small ones. If the process is sufficiently rapid, the colloid will be unstable. On the other hand control of this process is useful in production of photographic emulsions. In frozen foods, it can lead to deterioration during long term storage as the larger ice crystals will tend to grow at the expense of the smaller ones leading to tissue damage.

Gels

Gels are formed when the interactions between the particles in the disperse phase are strong enough to form a rigid network. In such a case, the colloid behaves as a solid and under moderate shear stresses behaves elastically. In effect, a gel comprises a continuous floc filling the whole system.

In the case of gels based on macromolecules, there are regions of the molecules where there is attraction to other molecules—often in the form of hydrogen bonding, or via some form of ionic stabilization. The result, as in gels based on flocs, is a three dimensional network which behaves as if it were a solid.

Swelling of Gels

The formation of the 3-D network that comprises a gel results in continuous phase being trapped within the gel. In many cases, the continuous phase is a solution and the floc network acts as a semi-permeable membrane. As a result, osmosis takes place and the gel will swell. The swelling tendency can be counteracted by applying an external pressure, the pressure required being known as the swelling pressure. This can reach quite high values. For example, driving wooden wedges into rock and soaking the wood can cause a sufficient swelling pressure to break the stone.

HYDROCOLLOIDS

Hydrocolloids are hydrophilic polymers, of vegetable, animal, microbial or synthetic origin, that generally contain many hydroxyl groups and may be polyelectrolytes. They are naturally present or added to control the functional properties of aqueous foodstuffs. Most important among these properties are viscosity (including thickening and gelling) and water binding but also significant are many others including emulsion stabilization, prevention of ice recrystallization and organoleptic properties.

Foodstuffs are very complex materials and this together with the multifactorial functionality of the hydrocolloids have resulted in several different hydrocolloids being required, the most important of which are: alginate, arabinoxyolan, carragenan, carboxymethylcellulose, cellulose, gelatin, beta-glucan, guar gum, gum arabic, locust bean gum, pectin, starch, xanthan gum.

Each of these hydrocolloids consists of mixtures of similar, but not identical, molecules and different sources, methods of preparation, thermal processing and foodstuff environment (e.g. salt content, pH and temperature) all affect the physical properties they exhibit. Descriptions of hydrocolloids often present idealized structures but it should be remembered that they are natural products (or derivatives) with structures determined by stochastic enzymic action, not laid down exactly by the genetic code. They are made up of mixtures of molecules with different molecular weights and no one molecule is likely to be conformationally identical or even structurally identical (cellulose excepted) to any other.

Mixtures of hydrocolloids show such a complexity of non-additive properties that it is only recently that these can be interpreted as a science rather than an art. There is enormous potential in combining the structure-function knowledge of polysaccharides with that of the structuring of water. The particular parameters of each application must be examined carefully, noting the effects required (e.g. texture, flow, bite, water content, stability, stickiness, cohesiveness, resilience, springiness, extensibility, processing time, process tolerance) and taking due regard of the type, source, grade and structural heterogeneity of the hydrocolloid(s).

All hydrocolloids interact with water, reducing its diffusion and stabilizing its presence. Generally neutral hydrocolloids are less soluble whereas polyelectrolytes are more soluble. Such water may be held specifically through direct hydrogen-bonding or the structuring of water or within extensive but contained inter- and intra-molecular voids. Interactions between hydrocolloids and water depend on hydrogen-bonding and therefore on temperature and pressure in the same way as water cluster formation. Similarly, there is a reversible balance between entropy loss and enthalpy gain but the process may be kinetically limited and optimum networks may never be achieved. Hydrocolloids may exhibit a wide range of conformations in solution as the links along the polymeric chains can rotate relatively freely within valleys in the potential energy landscapes. Large, conformationally stiff hydrocolloids present essentially static surfaces encouraging extensive structuring in the surrounding water. Water binding affects texture and processing characteristics, prevents syneresis and may have substantial economical benefit. In particular, hydrocolloids can provide water for increasing the flexibility (plasticizing) of other food components. They can also effect ice crystal formation and growth so exerting a particular influence on the texture of frozen foods. Some hydrocolloids, such as locust bean gum and xanthan gum, may form stronger gels on freeze-thaw due to kinetically irreversible changes consequent upon forced association as water is removed (as ice) on freezing.

As hydrocolloids can dramatically affect the flow behavior of many times their own weight of water, most hydrocolloids are used to increase viscosity (see rheology) , which is used to stabilize foodstuffs by preventing settling, phase separation, foam collapse and crystallization. Viscosity generally changes with concentration, temperature and shear strain rate in a complex manner dependent on the hydrocolloid(s) and other materials present. Mixtures of hydrocolloids may act synergically to increase viscosity or antagonistically to reduce it.

Many hydrocolloids also gel, so controlling many textural properties. Gels are liquid-water-containing networks showing solid-like behavior with characteristic strength, dependent on their concentration, and hardness and brittleness dependent on the structure of the hydrocolloid(s) present. Hydrocolloids display both elastic and viscous behavior where the elasticity occurs when the entangled polymers are unable to disentangle in time to allow flow. Mixtures of hydrocolloids may act synergistically, associating to precipitate, gel or form incompatible biphasic systems; such phase confinement affecting both viscosity and elasticity. Hydrocolloids are extremely versatile and they are used for many other purposes including (a) production of pseudoplasticity (i.e. fluidity under shear) at high temperatures to ease mixing and processing followed by thickening on cooling, (b) liquefaction on heating followed by gelling on cooling, (c) gelling on heating to hold the structure together (thermogelling), (d) production and stabilization of multiphase systems including films.

These properties of hydrocolloids are due to their structural characteristics and the way they interact with water. For example:

Hydrocolloids gel when intra- or inter-molecular hydrogen-bonding (and sometimes salt formation) is favored over hydrogen bonding (and sometimes ionic interactions) to water to a sufficient extent to overcome the entropic cost. Often the hydrocolloids exhibit a delicate balance between hydrophobicity and hydrophilicity. Extended hydrocolloids tend to tangle at higher concentrations and similar molecules may be able to wrap around each (forming helical junction zones) other without loss of hydrogen bonding but reducing conformational heterogeneity and minimizing hydrophobic surface contact with water so releasing it for more energetically favorable use elsewhere. Under such circumstances a minimum number of links may need to be formed (i.e. a junction zone which, if helical, generally requires a complete helix) to overcome the entropy effect and form a stable link. Where junction zones grow slowly with time, the interactions eliminate water and syneresis may occur (as in some jam and jelly).

Polysaccharide hydrocolloids stabilize emulsions primarily by increasing the viscosity but may also act as emulsifiers, where their emulsification ability is reported as mainly being due to accompanying (contaminating or intrinsic) protein moieties. In particular, electrostatic interaction between ionic hydrocolloids and proteins may give rise to marked emulsification ability with considerable stability so long as the appropriate pH and ionic strength regime is continued. Denaturation of the protein is likely to lead to improved emulsification ability and stability.

Mixtures of hydrocolloids may avoid self-aggregation at high concentration due to structural heterogeneity, which discourages crystallization but encourages solubility. Hydrocolloids may interact with other food components such as aiding the emulsification of fats, stabilizing milk protein micelles or affecting the stickiness of gluten.

The particle size of hydrocolloids and its distribution are important parameters concerning the rate of hydration and emulsification ability.

Negatively charged hydrocolloids change their structural characteristics with counter-ion type and concentration (including pH and ionic strength effects); e.g. at high acidity the charges disappear and the molecules become less extended.

Physical characteristics may be controlled by thermodynamics or kinetics (and hence processing history and environment) dependent on concentration. In particular these may change with time in an monotonic or oscillatory manner.

Different hydrocolloids prefer low-density or higher density water and other hydrocolloids show compatibility with both. As more intra-molecular hydrogen-bonds form so the hydrocolloids become more hydrophobic and this may change the local structuring of the water. Mixed hydrocolloids preferring different environments produce ‘excluded volume’ effects on each others effective concentration and hence rheology.

In the glassy state, conformational changes are severely inhibited, but the water held by hydrocolloids may act as plasticizer (allowing molecular motion) greatly reducing the glass transition temperature by breaking inter-molecular hydrogen-bonding.

Gums and Starches: Controlling Moisture Behavior

Understanding the mechanics of water's interactions within foods and how to apply polysaccharides such as gums and starches to control these interactions allows designers to take steps to improve product quality and extend shelf life.

A classic example of this is dough for baked products. Here, water not only is the solvent that activates chemical and/or yeast leaveners, but is a processing aid allowing the gluten development that leads to the formation of a mixable, cohesive mass (dough) that subsequently can be formed and baked. The starches and gums themselves are polymeric ingredients that require activation by water as a plasticizer.

Gums and starches are polysaccharides consisting of a straight molecular chain. Gums have a functional group on one end of this chain and starches have various branches on the chain. The exact configuration varies depending on the material's source

In unmodified forms, both absorb water, swell in solution and act as mild viscosifiers. When activated by heat and/or mechanical action, gum and starch particles both reorganize. Here is where the two begin to behave differently. Hydrated gums molecules have an affinity for one another and will gel. Starches, on the other hand, continue to act as individual molecules with an increased thickening capability. Various gums and starches behave in different ways and modifications of the basic material make even more variations possible (i.e. pregelatinized starch and cold-swelling gums.)

Flavor Components.

Water activity represents an important variable that influences the rate of many chemical reactions of flavor compounds. In complex aqueous systems, the way a food matrix is structured is of great importance to flavor release and flavor perception.

In aqueous food systems polysaccharides and proteins are generally the major components determining the structure of food products. Hydration of these macromolecular components is of primary importance in order to follow up the consequences when other smaller molecules, such as aroma compounds, are present. The way these volatile compounds are trapped in food systems will determine flavor release and thus, flavor perception and the appearance of a product to the consumer.

Physico-chemical reactions involving flavor components—whether between flavors, or between flavors and nonflavor components of food and the environment—are loosely termed “flavor interactions.” These interactions influence the quality, quantity, stability and the ultimate perception of flavor in food. Flavor is primarily a combination of taste and odor, and along with appearance and texture, comprises the criteria for sensory acceptance of foods.

The term “artificial flavors” refers to those flavors that are added to foods, or consisting of compounds not existing in nature. Naturally occurring flavors, or those formed by heating, aging or fermentation, are considered “natural flavors.” Naturally occurring flavors that are synthesized for addition to foods take on the label “nature-identical” flavors.

Fruit flavors are formulated and compounded for specific applications. The goal of the product designer is to select flavors that perform optimally within the context of a chemically reactive food product. Successfully achieving this goal requires knowledge of flavor interactions.

Physical and chemical flavor interactions occur continuously during food growing, harvesting, processing, storage and consumption. Interactions can be attributed to various types of chemical bonding: covalent bonding, hydrogen bonding, hydrophobic bonding, and the formation of inclusion complexes. The most commonly measured physical aspects of flavor interactions are binding, partitioning and release. Binding refers to the absorption of volatile and nonvolatile components of flavor onto the constituents of the food matrix. Partitioning describes the distribution of flavors in the aqueous, lipid or gas phases associated with the foodstuff and the package. The point at which flavor is made available to human sensory receptors is termed “release.” Optimizing the time for flavor release is product-dependent, since longer times are needed for foods that are well-chewed than for drinks that spend only a few seconds in the mouth.

Flavors partition themselves between the oil and water phases differentially, based on the chemical structure of the flavor and the chain length of the fatty acids present. In foods in which fat has been reduced, the flavor release is affected by this partitioning, since flavorants in aqueous systems possess a higher equilibrium vapor pressure than lipid systems. Volatiles release more quickly from aqueous systems, and dissipate, resulting in less of a flavor impression on the human sensory organs.

Proteins possess little flavor of their own, but they bind several volatile flavor components particularly well in the presence of heat denaturation. Binding, due to hydrophobic interactions and hydrogen-bonding, is reversible, as in the case of ketones, hydrocarbons and alcohol-based flavors. Covalent binding, such as Schiff base formation (aldehydes and amino groups), often is irreversible. Some of the factors influencing protein binding to volatiles are: temperature, pH, concentration and water presence. Proteins may bind more or less of a flavor component, depending on length and extent of heat treatment. In dairy proteins, several flavor components, such as a vanillin, benzaldehyde and d-limonene, were reduced by as much as 50% in solutions containing whey proteins or sodium caseinate. Protein-flavor binding can reduce the impact of desirable flavors and carry undesirable flavors to sensory receptors. The most widely studied, documented protein-flavor interaction is the binding of off-flavors to soy proteins.

Carbohydrates serve several important flavor-enhancement functions. Ranging in size from small to large, they finction as sweeteners; browning-reaction participants; fat replacers; viscosity builders; and flavor encapsulators. Sugars serve as carriers for flavors by physical interaction in aqueous systems, and by chemical-binding in dry ingredients. Structures of larger carbohydrate molecules, such as starch and cyclodextrins, can form hydrophobic regions that serve as inclusion mechanisms for flavor compounds of a like, hydrophobic chemistry. The flavor molecules that fit into these hydrophobic regions are called “guest molecules.” These interactions are highly reversible, since no other chemical reaction takes place between the starch and the guest, other than the hydrophobic attraction. This interaction forms the basis for the molecular encapsulation of flavors.

Polysaccharides, particularly hydrocolloids and gelling agents, bind flavor components to varying degrees. When the concentration of flavors is held constant—and the level of polysaccharides increases—perception of aroma and taste decreases, as a result of viscosity. The sweetness of sucrose, for example, is decreased when the viscosity of a solution of guar gum or carboxymethylcellulose is increased.

Carbohydrates also alter the volatility of aroma compounds. When compared to flavor compounds in a water solution, the addition of mono- and disaccharides increases volatility, and the addition of polysaccharides decreases volatility. The effect of carbohydrates on volatility is particularly important in food systems that use fat replacers, since volatiles are released at a faster rate when lipid content is low, due to the weaker interactions of carbohydrates with hydrophobic flavor compounds.

Food matrices often are composed of proteins, carbohydrates and lipids, so interactions with flavors often occur between two or more components. The Maillard reaction (also known as nonenzymatic browning), in which reducing sugars react with amino acids to produce aromatic volatiles and browning products, is responsible for the flavors formed during thermal treatment of foods, such as chocolate, coffee, roasted meats, bakery items and caramel. The number and type of flavors produced by these reactions depends on the quantity and type of amino acids available to participate in the reaction mixture. In combination with lipid oxidation reactions, the Maillard reaction generates flavor compounds when carbonyl compounds (from degradation of sugar or lipids) react with amines or thiols during heating. Flavor reactions within a complex food matrix seldom occur in isolation, and are affected by the reactants, the intermediates and the products of other reactions.

Flavors and packaging interact as a result of three factors: migration of packaging or food components; permeation of the package by gas, water and organic vapors; and exposure to light.

Protecting flavors from interactions that diminish or degrade them involves minimizing processing influences (heat, pH); environmental factors (evaporation, oxygen); and chemical interactions with the food matrix. Flavor perception is related to the way aroma is released (or inversely retained) from food systems. Flavor release depends on the nature and concentration of flavor compounds present in the food, as well as on their availability for perception as a result of interactions between the major components and the flavor compounds in the food. Food compositional and structural factors, e.g. as a result of the presence of macromolecules, and eating behaviour determine perception and the extent of flavor release. Knowledge of binding behaviour of flavor compounds in relation to the major food components, their rates of partitioning between different phases, and the structural organization of food matrices is of great practical importance for the flavoring of foods, in determining the relative retention of flavors during processing or the selective release of specific compounds during processing, storage and mastication.

The major mechanisms likely to occur in flavor release, are (i) specific binding of aroma molecules and (ii) entrapment of these molecules within a matrix. Specific binding can occur for some aroma molecules with proteins or with amylose. Additionally, proteins and polysaccharides affect the kinetics of aroma release as they influence the transport of aroma through the food into the air phase. Therefore, in complex aqueous systems, the way a food matrix is structured is of great importance to flavor release and flavor perception.

Different mechanisms controlling flavor release are likely to occur in food systems. Diffusion phenomena influenced by the viscosity of the system, unspecific binding or specific bindings to one of the macromolecular components are possibilities for the interactions of flavor molecules within the food matrix.

OVERVIEW OF FOOD PROCESSING

Food processing is an umbrella term, which describes all the activities of manufacturing food and beverages for human consumption, as well as prepared feeds for animals. The industry is defined as food and kindred products by Standard Industrial Classification (SIC) 20.

Food processing tends to break down the inherent structures within food materials or ingredients to a varying extent, and is therefore concerned with all aspects of food—the chemical and physical properties of food and its constituents, the processing and production of food, and the packaging and marketing of food, which represent components of a food processing system. Food quality—texture, flavor release, nutrient availability, moisture migration, and microbial growth—are influenced and determined by the formation, stability and breakdown of structures within foods.

Food processing involves conversion of raw materials and ingredients into a consumer food or edible product. Food processing includes any action that changes or converts raw plant or animal materials into safe, edible, and more palatable foodstuffs. Improvement of storage or shelf life is another goal of food processing.

The purpose of food processing is to produce foods that between them provide constituents of a balanced diet, are free from contamination, are appealing in color, taste and texture.

Food processing also drives an array of flavor chemistry reactions and the perception of flavor also depends on how the flavorful compounds are released during eating. The relationships between the structural, mechanical and physicochemical properties of the food and the perception of flavor and the formation of flavor compounds during processing is dependent in part upon water hydration.

Food processing operations involve one or more of ambient temperature processing, mechanical processing, high temperature processing, low temperature processing, fermentation processing, and various post processing steps.

Ambient temperature processes include cleaning and sorting, peeling; shredding, chopping and milling; mixing, blending and forming. These often are preparation for subsequent operations.

Physical Separations include filtration, centrifuging; expression and extraction; membrane separations. These often involve recovering a particular component from a raw material.

High temperature processes have two major purposes: Safety through pasteurization and sterilization; cooking, which modifies flavor, texture, nutritional qualities. A single process may serve both functions simultaneously. High temperature processes include sterilization and pasteurization; blanching; baking and roasting; frying; microwave and infra-red heating.

The purpose of blanching is as a pretreatment for dehydration, sterilization, freezing. Heat is sufficient to inactivate enzymes but not to cook but under processing is as bad as over processing.

Baking and Roasting are essentially the same process involving dry heating in hot air. Baking usually refers to dough products. Roasting usually refers to meat, nuts and vegetables. The surface of the treated substance undergoes chemical changes developing color and flavor. The heat has nutritional effects in that the food easier to eat and digest, but there may be a loss of vitamins.

Frying is cooking in hot oil. Its purpose is to improve eating quality of the food (flavor, texture). Effects of frying are similar to those of baking. Because of direct contact between hot oil and food, frying is generally quicker than roasting or baking.

Microwave and infra red heating use electromagnetic radiation for heating. Microwave heating involves short wavelength radiation. The frequency of the waves coincides with the natural vibration frequency of water molecules. Infra red is radiation just beyond the visible light region of the spectrum. The energy is dependant on temperature, surface properties, shape of the bodies.

Processing at low temperatures involves slowing the rate of microbial growth, but does not kill microbes. Up to a point, the lower the temperature, the longer the shelf life. Below −10° C., all microbial growth stops, but some residual enzyme activity may remain. The main function of chilling and freezing, therefore, is for storage and prolonged shelf life.

Fermentation serves a number of purposes, including preservation, improving nutritional quality, improving digestibility, health benefits. There is a wide variety of fermented foods including dairy products, fermented meat and vegetables, beverages, bread, etc.

Post processing operations include packaging and storage. The purposes of these operations include protection, display, increase storage life. Increasingly modified atmospheres are being used to increase shelf life, often by reducing oxygen and increasing nitrogen content.

Packaging Materials

Main packaging materials include metals, paper and board, glass, and polymers. The metals most widely used with foods are steel (usually found in the form of tinplate involved in canning), and aluminum used for three major food applications, e.g. beverage cans, foil containers, aerosol cans.

Can Manufacture

Cans are produced in two major forms. Three piece with rolled and soldered side seams and two separate end enclosures. Two piece in which sides and one end are formed from flat sheet and are seamless. The ends are sealed by a double seal which is purely mechanical. The interior of cans is usually coated with a suitable “enamel” to protect against tainting the food.

Paper and Board Paper

Various grades of paper are used. Kraft paper is a strong paper often used for paper sacks. Vegetable parchment is a paper specially treated with acid to give it a closer, smoother texture. Sulphite paper is a lighter, weaker paper than kraft paper—often used as paper bags and sweet wrappers. Greaseproof paper is produced from sulphite pulp where the paper fibers are more thoroughly beaten to give a closer texture. It is resistant to oil and grease. Tissue is a soft resilient paper used for protection.

Aseptic Packaging

Aseptic packaging is a process where the food is sterilized then filled into sterile containers under sterilized conditions which will prevent recontamination. It differs from in-pack sterilization in that the containers and food are sterilized separately.

Aseptic Processing

The shorter processing times possible mean the food is less processed leading to less destruction of vitamins and loss processed of flavors. Because the packaging does not have to be heated, a wider range of packaging is available. However, care must be taken to ensure sterility during the packaging operation packaging. Aseptic processing permits longer shelf life at normal temperatures with higher quality products.

Polymers for Food Packaging

Polymers are macromolecules based on a repeating unit derived from a small molecule. They may be natural—e.g. polysaccharides or synthetic. They possess a variety of properties useful to food packaging. Examples of polymers include polyethylene, LDPE, HDPE, polypropylene, polystyrene, olyvinyl chloride (PVC), polyethylene, terephthallate (PET), polycarbonate, polyamide (nylon), cellulose (cellulose acetate, cellophane).

Polymers may be classified as thermoplastic, which melts on heating; or thermosetting, which decomposes on heating.

UNIT OPERATIONS IN FOOD

Evaporation

Evaporation is a process of concentrating a liquid by heating to evaporate the water. Evaporation may be used in foods for a number of purposes:

To pre-concentrate the food prior to some other process, usually drying or to reduce

transport costs

To improve the preservation qualities by reducing water activity eg. jam-making.

To produce a product in its own right e.g. evaporated milk, fruit drinks.

Heat for evaporation is usually provided by condensing steam. Hence the process involves transferring latent heat from the steam to the evaporated water. It is usual in food evaporation, to carry out the evaporation under vacuum. This reduces the boiling temperature of the liquid and hence reduces thermal damage to the food. For this reason, short residence times in the evaporator are desirable. The most common types of evaporator are the thin film type where the liquid is spread in a thin film over the inner surface of a set of tubes, the steam being supplied to the outside of the tubes. There are two types of thin film evaporator, climbing film and falling film. Where a high degree of concentration is required, then multiple effect evaporation is employed. This involves carrying out the evaporation in a series of stages with the vapor generated in one stage being used as the heating steam for the next stage. This results in a considerable degree of steam economy.

Drying

Drying or dehydration of foods involves removing the water from a food to reduce the moisture content to a very low level (usually below 5% wt). The purpose of drying foods is to extend the storage life by reducing the water activity to practically zero, thus inhibiting microbial growth and enzyme activity. The normal processes of drying involve applying heat to the food and the drying process often results in irreversible changes to the food, such as non-enzymic browning and, vitamin degradation protein denaturation. Unless carried out under carefully controlled conditions, drying can have a significant negative impact on the nutritional value of the food.

The Drying Process

Drying is normally carried out by heating the solid in air so that the water evaporates into the air. The drying process may be followed via a graph of moisture content vs time. The moisture content will eventually fall to a constant value. This is known as the equilibrium moisture content.

Drying Mechanisms

Constant rate drying occurs when the solid material is completely covered with a layer of water. Drying occurs by evaporation from the surface of the water layer and the rate is governed purely by the temperature and moisture content of the drying air. When sufficient water has evaporated so that a layer of water no longer covers the surface of the solid, water has to migrate from the interior of the solid by diffusion before it can evaporate from the surface of the solid. Under these circumstances, as the water content of the interior falls, the rate of diffusion to the surface falls and, hence the rate of evaporation falls.

Drying Rates and Times

In the constant rate period, the drying rate is governed by surface evaporation which is effectively a function of the rate of heat transfer to the surface of the wet solid.

Extraction

Solid-liquid extraction or leaching is a process of separating two solids by contacting the solid mixture with a solvent in which one solid is soluble and the other is insoluble. This process is widely used for recovering vegetable oils and also for instant tea and coffee and decaffeination of coffee. Extraction may be carried out batchwise or continuously. The most common way is using continuous countercurrent extraction in a manner similar to solvent extraction and adsorption.

FOOD ADDITIVES AND FOOD STRUCTURE

Important in making the food palatable and even attractive, these “minor” additive constituents of food often have little nutritional value. While they may be present naturally in food, they are often added to the food to ensure control and consistency of properties. Additives affect foods' rheology and texture, colloidal properties, colors, including browning of foods, and flavorings

Food additives are often considered to be any substance not normally consumed as a food by itself and not normally consumed as a typical ingredient of a food. Additives are incorporated into foods so as to modify the properties (including the processing properties) of the food in some way. A distinction should be made between food additives and food contaminants. A contaminant is an undesirable substance present in the food, which it is not feasible to completely remove (either for technical or economic reasons). An additive, on the other hand, is a substance, which is added deliberately for some specific purpose.

Food additives serve the following purposes:

1. Maintenance of the nutritional quality of food.

2. Enhancement of the keeping quality or stability of foods leading in a reduction of losses.

3. Making foods attractive to the consumer in a way that does not lead to deception.

4. Providing essential aids in food processing.

It is also known in the art to use additives unethically to deceive the consumer and to disguise the use of poor ingredients or faulty processing and handling techniques.

The major categories of food additives include

| E number | Type of additive |
|---|---|
| E1xx | Colors |
| E2xx | Preservatives |
| E3xx | Antioxidants, Emulsifiers, Stabilizers and Thickeners |
| E4xx | Sweeteners |
| E5xx | Mineral Salts |
| E6xx | Flavor Enhancers |
| E9xx | Waxes and glazing agents |

Natural and Synthetic Additives

An additive can be called natural if it is actually isolated from a plant or animal source (using those terms broadly) or occurs in a plant or animal extract. If an additive is identical chemically to a compound occurring in nature but has actually been chemically synthesized, it referred to as nature identical. A synthetic additive is one which does not occur in nature and must be produced synthetically, such as a fermentation process or by other biotechnological methods.

The invention includes the following subject matter, described in United States Class 426 of the Manual of Patent Classification. The categories, definitions, and examples set forth therein are to be interpreted according to the class definitions (and lines with related compound, process, and product classes) and patentable subject matter classified therein as set forth in United States Class 426 of the Manual of Patent Classification, which is hereby incorporated by reference.

A. Structured (Microclustered) Edible Products or Compositions

1. Products or compositions which historically have been considered to be a food, and products or compositions which contain a naturally occurring material (i.e., plant or animal tissue) which has been historically regarded as a food; e.g., milk, cheese, apples, bread, dough, bacon, whiskey, etc.).

2. Products or compositions which are known to have or are disclosed as having nutritional effect.

3. Products or compositions which are closed or claimed as being edible or which; perfect, modify, treat, or are used in conjunction with an edible such as (1) or (2) above or with another edible, so as to become part of the edible composition or product, or which converts a nonedible to an edible form.

4. Mixtures of enzymes which are edible, per se, or which are used in preparing a product or composition proper for food or edible material.

5. Products or compositions involved in foods or in compositions for making foods which contain a live micro-organism which enhances or perfects the digestive action of the intestinal tract, e.g., Bacillus acidophilus milk, etc.

6. Edible products or compositions which have structural characteristics.

7. Plural inorganic elements or minerals for fortification.

8. Edible bait.

B. Edible Food Products in Combination with Nonfood Materials which are Generally:

1. Products or compositions of A above in combination with a package structure, inedible casing, a liner or base, an infusion bag, etc.

2. Compounds which have the same function as in (A. 1-3) in combination with an inedible material.

3. Potable water in a package.

4. Chewing gum and chewing gum bases, per se.

C. Flavoring And Sweetening Compositions

1. Flavoring compositions wherein at least one of the ingredients is not a carbohydrate type material.

2. Sweetening compositions wherein at least one of the ingredients is a noncarbohydrate type material.

D. Processes of Administering the Products or Composition of A-C above to an Animal Via the Oral Cavity.

F. Processes of Administering A Compound having the Same Function as the Compositions or Products of A-C Above to an Animal Via the Oral Cavity.

G. Processes of Treating Live Animals with a Product, Compound, or Ferment that Perfects he Food Made from Said Animal in Combination with a Butchering Operation, or Processes of Removing a Food Product from a Live Animal Followed by a Treatment of the Removed Food, or a Butchering Operation Followed by an Operation.

H. Processes of Preparing Treating or Perfecting the Products or Compositions of A-C.

I. Single Use Infusion Containers or Receptacles which are Specific for Preparing A Food and which are Devoid of Structure which Specifically Cooperates with A Food Apparatus.

J. Compositions and Methods of Use for Treating or Perfecting A Food Material.

What is claimed is:

1. A method of hydrating at least one of an ingredient and product of a food processing system, said method comprising the step of contacting for a sufficient period a sufficient aliquot of microclustered water with at least one of said ingredient and product, thereby forming at least one of a microclustered ingredient and microclustered product.

2. The method of claim 1 wherein said product is selected from the group consisting of
(a) an edible product or composition,
(b) an edible food product which comprises micro-clustered water in combination with nonfood material,
(c) a flavoring composition, and
(d) a sweetening composition.

3. The method of claim 1 wherein said ingredient includes one or more ingredients selected from one or more of the group consisting of amino acids, peptides, proteins, lipids, carbohydrates, aroma substances, vitamins, minerals, and food additives.

4. The method of claim 2 wherein said edible product is food made from a live animal subjected to a step of treatment with microclustered ingredient and/or microclustered product, said step of treatment combined further with a step selected from the group of steps consisting of:
a. a butchering operation
b. removing a food product from a live animal followed by a treatment of the removed food, and
c. a butchering operation followed by a treatment of butchered product.

5. An edible product or composition which comprises micro-clustered water.

6. The edible product or composition of claim 5 which further comprises nonfood material.

7. A flavoring composition which comprises micro-clustered water.

8. A sweetening composition which comprises micro-clustered water.

9. A method of administering via the oral cavity a micro-clustered food product or composition to an animal or human, said method comprising the step of feeding to the human or animal food products or compositions which comprise microclustered water.

10. The method of claim 9 wherein said microclustered product or composition is selected from the group consisting of
(a) edible product or composition which comprises micro-clustered water,
(b) edible food product which comprises micro-clustered water in combination with nonfood material,
(c) flavoring composition which comprises micro-clustered water, and
(d) sweetening composition which comprises micro-clustered water.
